(19) United States
(12) Patent Application Publication
(10) Pub. No.: US 2017/0308620 A1
(43) Pub. Date: Oct. 26, 2017

(54) MAKING GRAPH PATTERN QUERIES BOUNDED IN BIG GRAPHS

(71) Applicant: Futurewei Technologies, Inc., Plano, TX (US)

(72) Inventors: Yang Cao, Edinburgh (UK); Wenfei Fan, Edinburgh (UK); Jinpeng Huai, Beijing (CN)

(73) Assignee: Futurewei Technologies, Inc., Plano, TX (US)

(21) Appl. No.: 15/135,046

(22) Filed: Apr. 21, 2016

(51) Int. Cl. G06F 17/30

(52) U.S. Cl. CPC G06F 17/30958; G06F 17/30091; G06F 17/30463

(57) ABSTRACT

A processor executes instructions stored in non-transitory memory storage to receive a pattern query for a graph and determine a set of access constraints corresponding to the pattern query. A determination is made whether the pattern query is effectively bounded under the set of access constraints. A query plan is formed to retrieve a subgraph of the graph when the pattern query is effectively bounded under the set of access constraints. The answer to the pattern query is obtained by accessing the at least one subgraph in response to the query plan.

### BACKGROUND

Graph pattern matching includes finding a set of matches to a pattern query of a big graph that may stored in a graph database. Graph pattern matching may be used in social marketing, knowledge discovery, mobile network analysis, intelligence analysis for identifiying terrorist organizations and the study of adolescent drug use.

Querying a big graph to obtain an answer, or requesting particular information from a graph having a very large number of nodes and edges, may require a relatively fast device and still may take a relatively long amount of time. A big social graph may have about 1.26 billion nodes and 140 billion links (or edges). When a size of a big graph is about 1 petabyte (PB) (10¹⁵ bytes), a linear scan of the big graph may take about 1.9 days using a solid state drive processor with a read speed of about 6 GB/s (Gigabytes/second). Moreover, graph pattern matching of a big graph may be intractable under certain circumstances.

Reducing an amount of time to obtain an answer to a query of big graph while not increasing read speed of a solid state drive processor may result in search efficiency.

### SUMMARY

A processor executes instructions stored in non-transitory memory storage to receive a pattern query for a big graph and determine a set of access constraints corresponding to the pattern query. Access contraints may include cardinality contraints and indices. A determination is made whether the pattern query is effectively bounded under the set of access constraints. A query plan is formed to retrieve at least one matching subgraph of the big graph when the pattern query is effectively bounded under the set of access constraints. The answer to the pattern query is obtained by accessing the at least one subgraph in response to the query plan. A pattern query that is not effectively bounded may be made bounded by adding a constraint, such as a natural number, to the set of constraints. A graph pattern query may be localized, such as via subgraph isomorphism, or non-localized, such as simulation pattern graphs.

In one embodiment, the present technology relates to a device comprising a non-transitory memory storage having instructions and one or more processors in communication with the memory. The one or more processors execute the instructions to: receive a pattern query for a graph and determine a set of access constraints corresponding to the pattern query. A determination is made whether the pattern query is effectively bounded under the set of access constraints. A query plan is formed to retrieve a subgraph of the graph when the pattern query is effectively bounded under the set of access constraints. An answer to the pattern query is obtained by accessing the subgraph in response to the query plan.

In another embodiment, the present technology relates to a computer-implemented method for retrieving data from a dataset. The computer-implemented method comprises receiving, with one or more processors, a pattern query for a graph database having a plurality of nodes and edges. A plurality of access constraints corresponding to the pattern query is determined as well as whether the pattern query is effectively bounded under the plurality of access constraints. The pattern query is made into a bounded pattern query when the pattern query is not effectively bounded under the plurality of access constraints. A query plan is formed based on the bounded pattern query or pattern query to retrieve a plurality of subgraphs from the graph database. The plurality of subgraphs is obtained from the graph database by executing the query plan and an answer to the pattern query is retrieved by accessing the plurality of subgraphs.

In a further embodiment, the present technology relates to a non-transitory computer-readable medium storing computer instructions, that when executed by one or more processors, cause the one or more processors to perform steps. The steps include receiving a request for information and parsing the request for information into a pattern query for a graph database. A set of accesses constraints of the pattern query is determined for the graph database. A determination is made as to whether an amount of time to answer the request for information is not dependent on a size of the graph database. A query plan is formed based on the pattern query to retrieve a plurality of subgraphs from the graph database that match the pattern query. The plurality of subgraphs is obtained from the graph database by executing the query plan. An answer to the request for information is retrieved by accessing the plurality of subgraphs from the graph database. The answer to the request for information is then outputted.

This Summary is provided to introduce a selection of concepts in a simplified form that are further described below in the Detailed Description. This Summary and/or headings are not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a diagram illustrating determining matches of a pattern query in a graph database stored in memory storage according to embodiments of the present technology.

FIG. 2 illustrates a pattern query according to embodiments of the present technology.

FIG. 3 is a flowchat that illustrates a method to determine types of access constraints according to embodiments of the present technology.

FIG. 4 illustrates a simulation pattern query and graph according to embodiments of the present technology.

FIGS. 5a-b illustrates a method to determine whether a subgraph query is effectively bounded according to embodiment of the present technology.

FIG. 6 is a flowchart that illustrates a method to determine whether a subgraph query is effectively bounded according to embodiments of the present technology.

FIG. 7 illustrates a method to determine a query plan according to embodiments of the present technology.

FIG. 8 is a flowchart that illustrates a method to determine whether pattern queries may be made instance-bounded according to embodiments of the present technology.

FIGS. 9a-9l illustrate effectiveness of effectively bounded query evaluations according to embodiments of the present technology.

FIG. 10a-10b illustrate effectiveness of instance-boundedness according to embodiments of the present technology.

FIGS. 11-13 are flowcharts that illustrate methods to obtain information, such as an answer to a pattern query, from a graph according to embodiments of the present technology.

FIG. 14 is a block diagram that illustrates a system architecture to retrieve information from a graph database according to embodiments of the present technology.

FIG. 15 is a block diagram that illustrates a computing device architecture to retrieve information from a graph database according to embodiments of the present technology.

FIG. 16 is a block diagram that illustrates a software architecture to retrieve information from a graph database according to embodiments of the present technology.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

The present technology, roughly described, relates to retrieving information from big graphs, or graph datasets that are very large and/or complex. A big graph may contain a very large number of nodes and edges stored in a graph database. Information, or an answer to a pattern query, may be obtained from the big graph by determining one or more subgraphs of the big graph that match an effectively bounded pattern query.

In an embodiment, a processor executes instructions stored in non-transitory memory storage to receive a pattern query for a big graph and determine a set of access constraints corresponding to the pattern query. Access contraints may include cardinality constraints and indices. A determination is made whether the pattern query is effectively bounded under the set of access constraints. A query plan is formed to retrieve at least one matching subgraph of the big graph when the pattern query is effectively bounded under the set of access constraints. The answer to the pattern query is obtained by accessing the at least one subgraph in response to the query plan.

A pattern query that is not effectively bounded may be made bounded by adding a constraint, such as a natural number, to the set of constraints. A pattern query may be localized, such as via subgraph isomorphism, or non-localized, such as simulation pattern queries. Experimental results are provided to show the effectiveness of the technology described herein.

It is understood that the present technology may be embodied in many different forms and should not be construed as being limited to the embodiments set forth herein. Rather, these embodiments are provided so that this disclosure will be thoroughly and completely understood. Indeed, the disclosure is intended to cover alternatives, modifications and equivalents of these embodiments, which are included within the scope and spirit of the disclosure as defined by the appended claims. Furthermore, in the following detailed description, numerous specific details are set forth in order to provide a thorough understanding of the technology. However, it will be clear that the technology may be practiced without such specific details.

In an embodiment, big graph is a broad term for graph datasets so large and/or complex that traditional data processing applications are inadequate. Challenges include analysis, capture, data curation, search, sharing, storage, transfer, visualization, querying and information privacy. Accuracy in obtaining information from big graphs may lead to more confident decision making, and better decisions can result in greater operational efficiency, cost reduction and reduced risk.

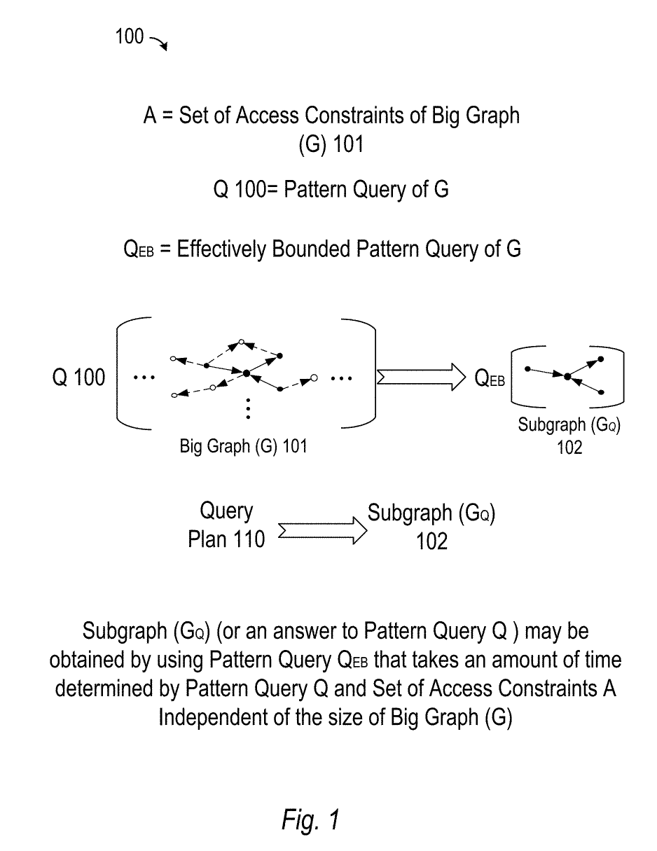

FIG. 1 is a diagram illustrating retrieving one or more subgraphs 102 of big graph G, stored in memory as a graph database, by determining whether a query (Q) 100 to big graph G is an effectively bounded query Q_{EB} according to an embodiment. A set A of access constraints of big graph G, including a combination of indices and cardinality constraints, may be used to determine whether query 100 is an effectively bounded query Q_{EB}. When a query 100 is an effectively bounded query Q_{EB}, a query plan 110 having one or more fetch operations may be formed to access a one of more subgraphs 102 at a far lower cost or amount of time as compared to using query 100. The one or more subgraphs 102 may then be accessed to answer pattern query Q.

Rather than determining matches Q(G) of a pattern query Q in a graph G, which may be cost-prohibitive, one or more small subgraphs G_{Q} of graph G are identified, such that Q(G_{Q})=Q(G). In embodiments, pattern queries are effectively bounded under access constraints A, such that subgraph G_{Q} may be identified in time determined by pattern query Q and A only, independent of the size |G| of graph G in an embodiment. Pattern queries may be localized (e.g., via subgraph isomorphism) or non-localized (graph simulation). Methods are described herein to determine whether a pattern query Q is effectively bounded, and when so, to generate a query plan that computes Q(G) by accessing subgraph G_{Q}, in time independent of |G|. When pattern query Q is not effectively bounded, methods are described herein to extend access constraints and make pattern query Q bounded in graph G. Experimental results verify the effectiveness of the technology described herein, e.g., about 60% of queries are effectively bounded for subgraph isomorphism, and for such queries, embodiments described herein outperform typical methods by 4 orders of magnitude.

In particular, for a pattern query Q and a graph G, graph pattern matching determines a set Q(G) of matches of pattern query Q in graph G. Graph pattern matching, a form of data mining, may be used in social marketing, knowledge discovery, mobile network analysis, intelligence analysis for identifying terrorist organizations, and the study of adolescent drug use, for example.

When graph G is big, graph pattern matching may be cost-prohibitive. A social network may have 1.26 billion nodes and 140 billion links in its social graph, about 300 PB of user data. When a size |G| of graph G is 1PB, a linear scan of graph G takes 1.9 days using a solid state device (SSD) with scanning speed of 6 GB (Gigabytes)/s (sec). Graph pattern matching may be intractable when it is defined with subgraph isomorphism, and it takes O((|V|+|V_{Q}|)(|E|+|E_{Q}|))—time when graph simulation are used, where |G|=|V|+|E| and |Q|=|V_{Q}|+|E_{Q}|.

Exact answers to Q(G) may be efficiently computed when graph G is big while constrained resources are used, such as a single processor. Making big graphs small may be used, capitalizing on a set A of access constraints, with the set A of access constraints comprising a combination of indices and cardinality constraints defined on the labels of neighboring nodes of graph G. A determination is made whether pattern query Q is effectively bounded under A, i.e., for all graphs G that satisfy A, there exists a subgraph G_{Q}⊂G, such that:

Q(G_{Q})=Q(G), and

the size |G_{Q}| of G_{Q} and the time for identifying G_{Q} are both determined by A and pattern query Q only, independent of |G| in an embodiment.

When pattern query Q is effectively bounded, a query plan may be generated that for all graph G satisfying A, computes Q(G) by accessing (visiting/identifying and fetching) a small G_{Q} in time independent of |G|, no matter how big graph G is in an embodiment. Otherwise, additional access constraints are identified on an input graph G to make pattern query Q bounded in graph G.

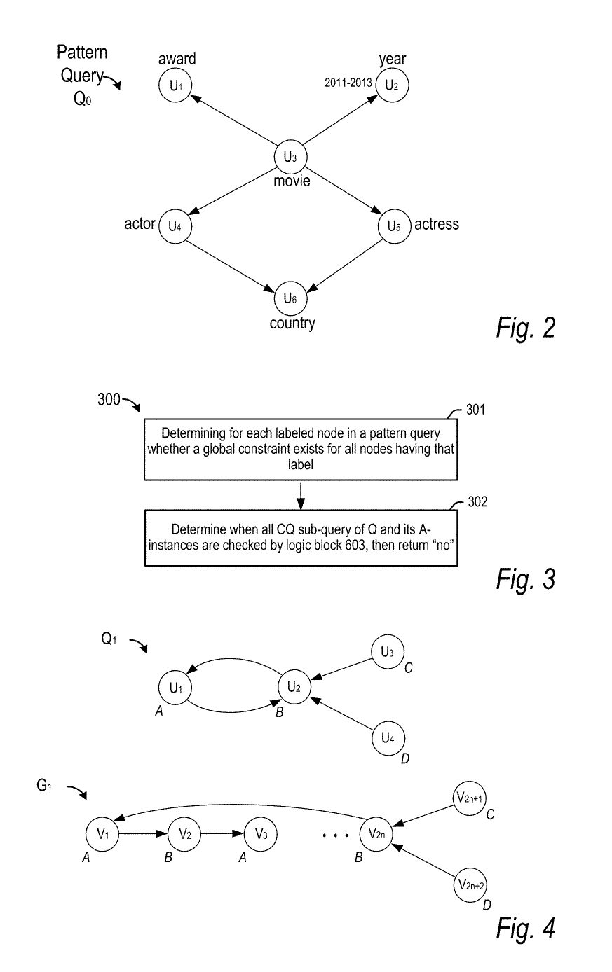

In an embodiment, graph pattern queries may be effectively bounded under access constraints, as illustrated in FIG. 2 and described in a first example below.

In a first example, consider an internet movie database (IMDb) as a graph G₀ in which nodes represent movies, casts, and awards from 1880 to 2014, and edges denote various relationships between the nodes. An example search on IMDB may be the following natural language query or request for information: “find pairs of first-billed actor and actress (main characters) from the same country who co-starred in a award-winning film released in 2011-2013”.

The search can be represented as a pattern query Q₀ as shown in FIG. 2. Graph pattern matching performed here is done to determine a set Q₀(G₀) of matches, i.e., subgraphs G′ of graph G₀ that are isomorphic to pattern query Q₀. Actor-actress pairs may be extracted and returned from each match subgraphs G′. Graph G₀ is a big graph in an embodiment. For example, graph G₀ may have 5.1 million nodes and 19.5 million edges. Also, subgraph isomorphism is NP-complete.

Aggregate queries may obtain the following cardinality constraints on a movie dataset from 1880-2014: (1) in each year, every award is presented to no more than 4 movies (C1); (2) each movie has at most 30 first-billed actors and actresses (C2), and each person has only one country of origin (C3); and (3) there are no more than 135 years (C4), i.e., 1880-2014), 24 major movie awards (C5) and 196 countries (C6) in total. An index may be built on the labels and nodes of graph G₀ for each of the constraints, yielding a set A₀ of eight access constraints, for example.

Under A₀, pattern query Q₀ is effectively bounded. Q₀(G₀) may be determined by accessing at most 17,923 nodes and 35,136 edges in graph G₀, regardless of the size of graph G₀, by the following query plan:

(a) identify a set V₁ of 135 year nodes, 24 award nodes, and 196 country nodes, by using the indices for constraints C4-C6;

(b) fetch a set V₂ of at most 24×3×4=288 award-winning movies released in 2011-2013, with no more than 288×2=576 edges connecting movies to awards and years, by using those award and year nodes in V₁ and the index for C1;

(c) fetch a set V₃ of at most (30+30)*288=17280 actors and actresses with 17280 edges, using V₂ and the index for C2;

(d) connect the actors and actresses in V₃ to country nodes in V₁, with at most 17280 edges, by using the index for C3. Output (actor, actress) pairs connected to the same country in V₁.

The query plan visits at most 135+24+196+288+17,280=17,923 nodes, and 576+17,280+17,280=35,136 edges, using the cardinality constraints and indices in A₀, as opposed to tens of millions of nodes and edges in IMDb.

The first example indicates that graph pattern matching is feasible in big graphs within constrained resources, by making use of effectively bounded graph pattern queries. The following embodiments are described: (1) For a pattern query Q and a set A of access constraints, a determination is made whether pattern query Q is effectively bounded under A, (2) when pattern query Q is effectively bounded, a query plan is generated to compute Q(G) in graph G by accessing a bounded graph G_{Q}, (3) When pattern query Q is not bounded, pattern query Q may be made “bounded” in graph G by adding additional constraints, and (4) Localized queries (e.g., via subgraph isomorphism) and non-localized queries (via graph simulation) may be used.

In particular, the following is described in detail below:

(1) Effective boundedness for graph pattern queries is described below. Access constraints on graphs and effectively bounded graph pattern queries are described. Access constraints obtained from typical data is also described.

(2) Effectively bounded subgraph pattern queries Q are described, i.e., patterns defined by subgraph isomorphism. Sufficient and necessary conditions are described to determine whether a pattern query Q is effectively bounded under a set A of access constraints. Using the condition, a method is described in O(|A∥E_{Q}|+∥A∥|V_{Q}|²) time, where |Q|+|V_{Q}|+|E_{Q}|, and ∥A∥ is the number of constraints in A. Cost is independent of a size of graph G, and pattern query Q is typically small in an embodiment.

(3) A method to generate query plans for effectively bounded subgraph queries is described in an embodiment. After a pattern query Q is determined effectively bounded under a set A of access constraints, a method generates a query plan that, for a graph G that satisfies set A of access constraints, accesses a subgraph G_{Q} of size independent of |G|, in O(|V_{Q}∥E_{Q}∥A|) time. Moreover, a query plan is worst-case-optimal, i.e., for each input pattern query Q and set A of access constraints, the largest subgraph G_{Q} determined from all graphs G that satisfy a set A of access constraints is a minimum among all worst-case subgraphs G_{Q} identified by all other query plans in an embodiment.

(4) When pattern query Q is not bounded under a set A of access constraints, pattern query Q is made instance-bounded. In other words, for a particular graph G that satisfies a set of A access constraints, an extension set A_{M} of access constrains of the set A of access constraints is determined such that under the extension set A_{M} of access constraints, G_{Q}⊂G in time decided by extension set A_{M} of access constraints and pattern query Q is determined as well as Q(G_{Q})=Q(G). When a size of indices in extension set A_{M} of access constraints is predetermined, a problem for determining an existence of extension set A_{M} of access constraints is in low polynomial time (PTIME), but it is log-APX-hard to find a minimum extension set A_{M} of access constraints. When extension set A_{M} of access contraints is unbounded, all query loads may be made instance-bounded by adding access constraints in an embodiment.

(5) Simulation pattern queries, i.e., query patterns interpreted by graph simulation, are similarly described. In particular, the non-localized and recursive nature of simulation pattern queries are described. A characterization of effectively bounded simulation pattern queries is described. Methods for determining effective boundedness, generating query plans, and for making simulation pattern queries instance-bounded for simulation pattern queries, with the same complexity, are provided.

(6) Methods are experimentally evaluated using typical data. In embodiments, methods described herein are effective for both localized and non-localized pattern queries: (a) on graphs G of billions of nodes and edges, query plans may outperform, by 4 and 3 orders of magnitude on average, typical methods that compute Q(G) directly for subgraph and simulation pattern queries, accessing at most 0.0032% of the data in graph G; (b) 60% (resp. 33%) of subgraph (resp. simulation) queries are effectively bounded under access constraints; and (c) pattern queries may be made instance-bounded in graph G by extending constraints and accessing 0.016% of extra data in graph G; and 95% become instance-bounded by accessing at most 0.009% extra data. In tested embodiments, methods described herein may take up to 37 ms to determine whether pattern query Q is effectively bounded and generate an optimal query plan for pattern query Q and constraints.

In an embodiment, querying graph G with a pattern query Q includes: (1) making a determination whether the pattern query Q is effectively bounded under a set A of access constraints. (2) When the pattern query Q is effectively bounded, a query plan for the particular graph G satisfying the set of A access constraints computes Q(G) by accessing subgraph G_{Q} of size independent of |G|, no matter how big graph G grows in an embodiment. (3) When the pattern query Q is not effectively bounded, pattern query Q is made instance-bounded in graph G with additional constraints. In an embodiment, both localized subgraph queries and non-localized simulation pattern queries may be used.

### Effectively Bounded Graph Pattern Queries

An access schema on graphs and effectively bounded graph pattern queries are described below.

Graphs. In an embodiment, A data graph (or graph) is a node-labeled directed graph G=(V,E,ƒ,v), where (1) V is a finite set of nodes; (2) E⊂V×V is a set of edges, in which (v,v′) denotes the edge from v to v′; (3) ƒ( ) is a function such that for each node v in V, ƒ(v) is a label in Σ, e.g., year; and (4) v(v) is the attribute value of ƒ(v), e.g., year=2011.

A graph G may be denoted as (V,E) or (V,E,ƒ), in an embodiment, when it is clear from the context. A size of graph G, denoted by |G|, is defined to be a total number of nodes and edges in graph G, i.e., |G|=|V|+|E|, in an embodiment. A graph G may also be referred to as a big graph G unless the context indicates otherwise.

Edge labels are not explicitly defined in an embodiment. Nonetheless, similar techniques may be adapted to edge labels. For example, for each labeled edge e, a “dummy” node may be inserted to represent e, carrying e's label.

Labeled Set.

For a set S⊂Σ of labels, V_{S}⊂V is a S-labeled set of graph G when (a) |V_{S}|=|S|, and (b) for each label l_{S} in set S, there exists a node v in V_{S} such that ƒ(v)=l_{S}. In particular, when set S=Ø, the S-labeled set in graph G is Ø.

Common Neighbors.

A node v is called a neighbor of another node v′ in graph G when either (v,v′) or (v′,v) is an edge in graph G. The node v is a common neighbor of a set V_{S} of nodes in graph G when for all nodes v′ in V_{S}, v is a neighbor of v′. In particular, when V_{S} is Ø, all nodes of graph G are common neighbors of V_{S}.

Subgraphs.

Graph Gₛ=(Vₛ, Eₛ, fₛ, vₛ) is a subgraph of graph G when Vs⊂V, Eₛ⊂E, and for each (v,v′)εEₛ, vεVₛ and v′εVₛ, and for each vεVₛ, fₛ(v)=f(v) and vₛ(v)=v (v).

Pattern Queries.

A pattern query Q is a directed graph (V_{Q}, E_{Q}, ƒ_{Q}, g_{Q}), where (1) V_{Q}, E_{Q} and ƒ_{Q} are analogous to their counterparts in data graphs; and (2) for each node u in V_{Q}, g_{Q}(u) is the predicate of u, defined as a conjunction of atomic formulas of the form ƒ_{Q}(u) op c, where c is a constant and op is one of =, >, <, ≦ and ≧. For instance, in pattern query Q₀ of FIG. 2, g_{Q}(year)=year≧2011 [symbol] year≦2013. A pattern query Q may be denoted as (V_{Q}, E_{Q}) or (V_{Q}, E_{Q}, ƒ_{Q}). Pattern queries may also be referred to as graph pattern queries unless the context indicates otherwise.

Two semantics of graph pattern matching are described below.

Subgraph Queries.

A match of pattern query Q in graph G via subgraph isomorphism is a subgraph G′(V′, E′, ƒ′) of graph G that is isomorphic to pattern query Q, i.e., there exists a bijective function h from V_{Q} to V′ such that: (a) (u,u′) is in E_{Q} when and only when (h(u),h(u′))εE′, and (b) for each uεV_{Q}, ƒ_{Q}(u)=ƒ′(h(u)) and g_{Q}(v(h(u))) evaluates to true, where g_{Q}(v(h(u))) substitutes v(h(u)) for ƒ_{Q}(u) in g_{Q}(u). In an embodiment, Q(G) is a set of all matches of pattern query Q in graph G.

Simulation Queries.

A match of pattern query Q in graph G via graph simulation is a binary match relation R⊂V_{Q}×V such that: (a) for each (u,v)εR, ƒ_{Q}(u)=ƒ(v) and g_{Q}(v(v)) evaluates to true, where g_{Q}(v(v)) substitutes v(v) for ƒ_{Q}(u) in g_{Q}(u); (b) for each node u in V_{Q}, there exists a node v in V such that (i) (u,v)εR, and (ii) for any edge (u,u′) in pattern query Q, there exists an edge (v,v′) in graph G such that (u′,v′)εR. Simulation queries may also be referred to as simulation pattern queries unless the context indicates otherwise.

For any pattern query Q and graph G, there exists a unique maximum match relation R_{M} via graph simulation (possibly empty). In an embodiment, Q(G) is defined to be R_{M}. Simulation queries a may be used in social community analysis and social marketing in embodiments.

Data Locality.

A pattern query Q is localized when for any graph G that matches pattern query Q, any node u and neighbor u′ of u in pattern query Q, and for any match v of u in graph G, there must exist a match v′ of u′ in graph G such that v′ is a neighbor of v in graph G. Subgraph queries are localized in an embodiment. Simulation queries are non-localized in an embodiment.

In a second example, consider a simulation pattern query Q₁ and graph G₁ shown in FIG. 4, where graph G₁ matches simulation pattern query Q₁. Then simulation pattern query Q₁ is not localized: u₂ matches v₂, . . . , v₂ₙ₋₂ and v₂ₙ, but for all kε[2,n], v₂ₖ₋₂ has no neighbor in graph G₁ that matches the neighbor u₃ of u₂ in Q₁. To decide whether u₂ matches v₂, all the nodes have to be inspected on an unbounded cycle in graph G₁.

Effective boundedness for subgraph queries as well as non-localized simulation queries are described below. To formalize effectively bounded patterns, access constraints on graphs are defined below in an embodiment.

Access Schema on Graphs.

An access schema A is a set of access constraints of the following form in an embodiment:

S→(l,N)

where S⊂Σ is a (possibly empty) set of labels, l is a label in Σ, and N is a natural number.

A graph G(V,E,ƒ) satisfies the access constraint when

for any S-labeled set V_{S} of nodes in V, there exist at most N common neighbors of V_{S} with label l; and

there exists an index on S for l such that for any S-labeled set V_{S} in graph G, it finds all common neighbors of V_{S} labeled with l in O(N)-time, independent of |G|.

Graph G satisfies access schema A, denoted by G|=A, when graph G satisfies all the access constraints in A in an embodiment.

An access constraint is a combination of: (a) a cardinality constraint, and (b) an index on the labels of neighboring nodes in an embodiment. Access constraints indicate that for any S-node labeled set V_{S}, there exist a bounded number of common neighbors Vₗ labeled with l, and moreover, Vₗ can be efficiently retrieved with the index.

In an embodiment, two special types of access constraints are as follows:

(1) |S|=0 (i.e., Ø→(l,N)): for any graph G that satisfies the constraint, there exist at most N nodes in graph G labeled l; and

(2) |S|==1 (i.e., l→(l′,N)): for any graph G that satisfies the access constraint and for each node v labeled with l in graph G, at most N neighbors of v are labeled with l′.

In other words, constraints of type (1) are global cardinality constraints on all nodes labeled l, and those of type (2) state cardinality constraints on l′-neighbors of each l-labeled node.

In a third example, constraints C1-C6 on IMDb described in the first example may be expressed as access constraints φᵢ (for iε[1,6]):
φ₁: (year, award)→(movie, 4);
φ₂: movie→(actors/actress, 30);
φ₃: actor/actress→(country, 1);
φ₄: →(year, 135);
φ₅: →(award, 24);
φ₆: →(country, 196).

In particular, φ₂ denotes a pair movie→(actors, 30) and movie→(actress, 30) of access constraints; similarly for φ₃. Note that φ₄-φ₆ are constraints of type (1); φ₂-φ₃ are of type (2); and φ₁ has the general form: for any pair of year and award nodes, there are at most 4 movie nodes connected to both, i.e., an award is given to at most 4 movies each year. A₀ is used to denote the set of these access constraints.

Effectively Bounded Patterns.

In an embodiment, a pattern query Q is effectively bounded under an access schema A when for all graphs G that satisfy A, there exists a subgraph G_{Q} of graph G such that:

(a) Q(G_{Q})=Q(G); and

(b) subgraph G_{Q} can be identified in time that is determined by pattern query Q and A only, not by |G| in an embodiment.

By (b), |G_{Q}| is also independent of the size |G| of graph G in an embodiment. In other words, pattern query Q is effectively bounded under A when for all graphs G that satisfy A, Q(G) can be computed by accessing a bounded subgraph G_{Q} rather than the entire graph G, and moreover, subgraph G_{Q} can be efficiently accessed by using access constraints of A. For instance, as shown in the first example, pattern query Q₀ is effectively bounded under the access schema A₀ in the second example.

Determining Access Constraints.

From experiments, many practical pattern queries are effectively bounded under access constraints S→(l,N) when |S| is at most 3. In an embodiment, access constraints may be determined as follows.

(1) Degree bounds: when each node with label l has degree at most N, then for any label l′, l→(l′,N) is an access constraint.

(2) Constraints of type (1): such global constraints are common in embodiments, e.g., φ₆ on IMDb: Ø→(country, 196).

(3) Functional dependencies (FD s): our familiar FD s X→A are access constraints of the form X→(A,1), e.g., movie→year is an access constraint of type (2): movie→(year, 1). Such constraints can be determined by shredding a graph into relations and then using available FD discovery tools in embodiments.

(4) Aggregate queries: such queries enable determination of semantics of the data, e.g., grouping by (year, country, genre) indicates (year, country, genre)→(movie, 1800), i.e., each country releases at most 1800 movies per year in each genre.

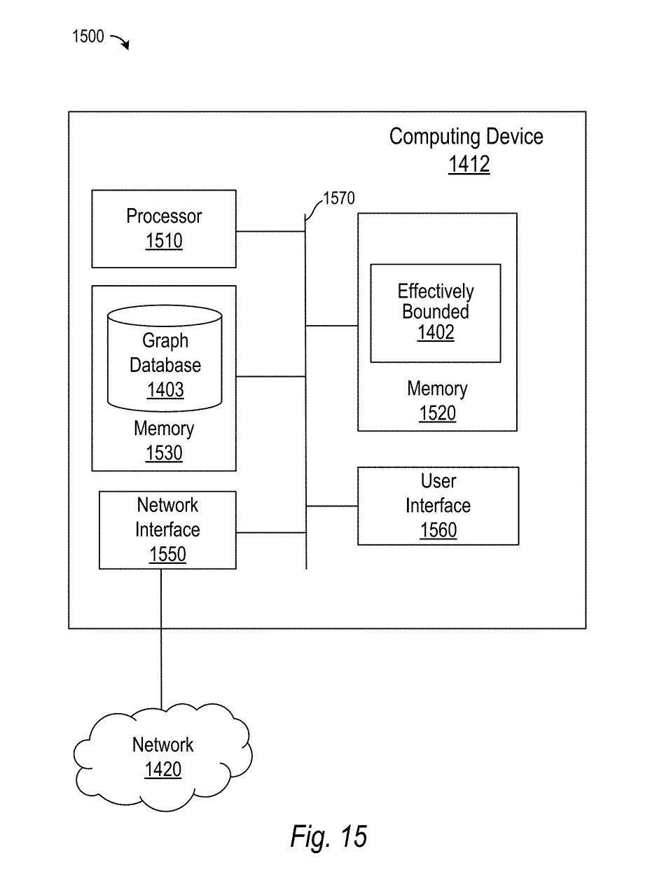

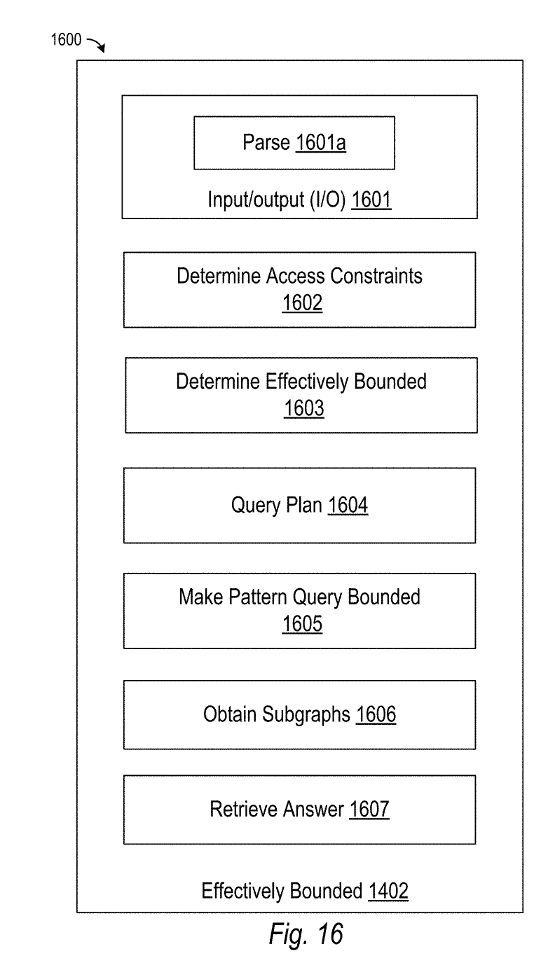

FIG. 3 is a flowchart that illustrates a method 300 to determine types of access constraints according to embodiments of the present technology. In an embodiment, determine access constraints 1602 in FIG. 16, executed by one or more processors, such as processor 1510 shown in FIG. 15, performs at least a portion of method 300.

Logic block 301 illustrates determining, for each labeled node in a pattern query, whether a global constraint exists for all nodes having that label. In an embodiment, logic block 301 determines whether a pattern query has one or more access constraints of type 1.

Logic block 302 illustrates determining whether cardinality constraints exist for neighbor nodes of each labeled node in the pattern query. In an embodiment, logic block 302 determines whether a pattern query has one or more access constraints of type 2.

Maintaining Access Constraints.

The indices in an access schema can be incrementally and locally maintained in response to changes to the underlying graph G. It suffices to inspect ΔG∪Nb_{G}(ΔG), where ΔG is the set of nodes and edges deleted or inserted, and Nb_{G}(ΔG) is the set of neighbors of those nodes in ΔG, regardless of how big graph G is.

### Effective Boundedness of Subgraph Queries

Effective boundedness, denoted by EBnd(Q,A), is described below:

Input: A pattern query Q(V_{Q},E_{Q}), an access schema A.

Question: Is pattern query Q(V_{Q},E_{Q}) effectively bounded under A?

In particular, subgraph queries are described below in that:

(a) there exists a sufficient and necessary condition, i.e., a characterization, for deciding whether a subgraph query Q is effectively bounded under A; and

(b) EBnd(Q,A) is decidable in low polynomial time in the size of pattern query Q and A, independent of any data graph.

Characterizing the Effective Boundness.

An effective boundedness of subgraph queries is characterized in terms of coverage, as follows.

A node cover of A on subgraph query Q, denoted by VCov(Q,A), is a set of nodes in subgraph query Q computed inductively as follows:

(a) when Ø→(l,N) is in A, then for each node u in subgraph query Q with label l, uεVCov(Q,A); and

(b) when S→(l,N) is in A, then for each S-labeled set V_{S} in subgraph query Q, when V_{S}⊂VCov(Q,A), then all common neighbors of V_{S} in subgraph query Q that are labeled with l are also in VCov(Q,A).

In other words, a node u is covered by A when in any graph G satisfying A, there exist a bounded number of candidate matches of u, and the candidates may be retrieved by using indices in A. In (a) above, u is covered when its candidates are bounded by type (1) constraints. In (b), when for some φ=S→(l,N) in A, u is labeled with l and is a common neighbor of V_{S} that is covered by A, then u is covered by A, since its candidates are bounded (by N and the bounds on candidate matches of V_{S}), and can be retrieved by using the index of φ.

Edge cover of A on subgraph query Q, denoted by ECov(Q,A), is a set of edges in subgraph query Q defined as follows: (u₁,u₂) is in ECov(Q,A) when and only when there exist an access constraint S→(l,N) in A and a S-labeled set V_{S} in subgraph query Q such that (1) u₁ (resp. u₂) is in V_{S} and V_{S}⊂VCov(Q,A) and (2) ƒ_{Q}(u₂)=l (resp. ƒ_{Q}(u₁)=l) in an embodiment.

In other words, (u₁,u₂) is in ECov(Q,A) when one of u₁ and u₂ is covered by A and the other has a bounded number of candidate matches by S→(l,N). Their matches in a graph G may be verified by accessing a bounded number of edges in an embodiment.

In an embodiment, VCov(Q,A)⊂V_{Q} and ECov(Q,A)⊂E_{Q}.

The node and edge covers characterize effectively bounded subgraph queries. In particular, a subgraph query Q is effectively bounded under an access schema A when and only when VCov(Q,A)=V_{Q} and ECov(Q,A)=E_{Q}.

In a fourth example, for pattern query Q₀(V₀,E₀) of FIG. 2 and access schema A₀ of the second example, VCov(Q₀,A₀)=V₀ and ECov(Q₀,A₀)=E₀ may be verified. From this and above, it follows that pattern query Q₀ is effectively bounded under A₀.

Determining Whether Subgraph Queries are Effectively Bounded.

Using the above characterization, a determination as to whether a subgraph query Q is effectively bounded under A is described below.

In particular, for subgraph queries Q, EBnd(Q,A) is in:

(1) O(|A∥E_{Q}|+∥A∥|V_{Q}|²) time in general; and

(2) O(|A∥E_{Q}|+|V_{Q}|²) time when either

for each node in subgraph query Q, its parents have distinct labels; or

all access constraints in A are of type (1) or (2).

|A| denotes a total length of access constraints in A, ∥A∥ is a number of constraints in A, and a node u′ is a parent of u in subgraph query Q when there exists an edge from u′ to u in subgraph query Q.

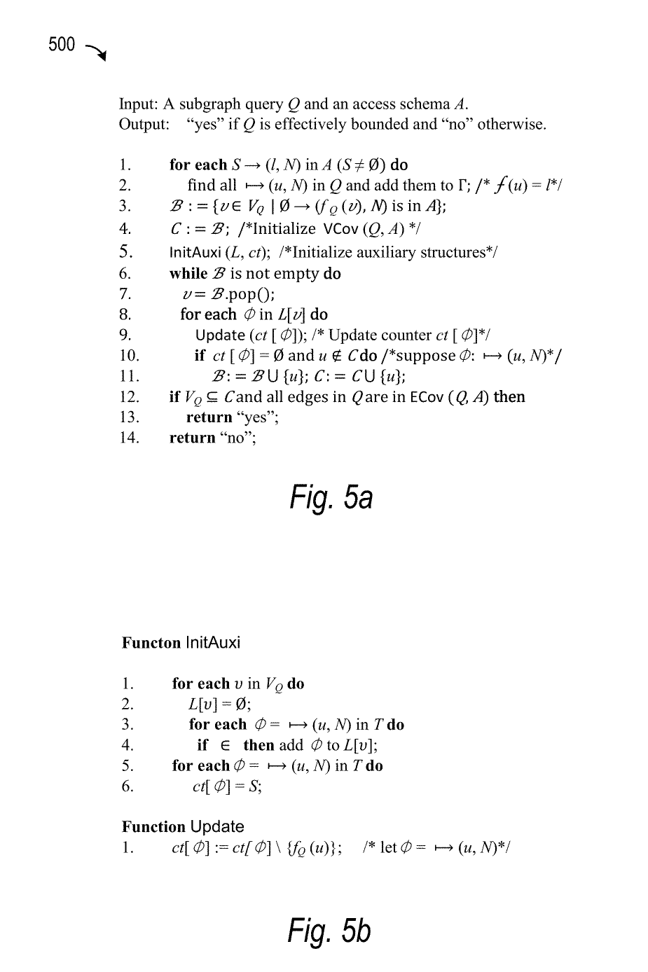

FIG. 5 illustrates a method 500 that determines whether a subgraph query Q with an access schema A is effectively bounded. Method 500 is also referred to as method EBChk unless the contents indicates otherwise. In an embodiment, method 500 is represented by psuedocode that may represent non-transitory instructions executed by one or more processors in an embodiment. For example, for a particular subgraph query Q(V_{Q},E_{Q}) and an access schema A, method 500 determines whether: (a) V_{Q}⊂VCov(Q,A), and (b) E_{Q}⊂ECov(Q,A); and returns “yes” when the conditions are met. To check these conditions, A on subgraph query Q is actualized. For each S→(l,N) in A (S≠Ø), and each node u in subgraph query Q with ƒ_{Q}(u)=l, the actualized constraint is V̅_{S}^{u} [symbol] (u,N), where V̅_{S}^{u} is the maximum set of neighbors of u in subgraph query Q such that: (a) there exists a S-labeled set V_{S}⊂V̅_{S}^{u}, and (b) for each u′ in V̅_{S}^{u}, ƒ_{Q}(u′)εS.

Actualized constraints aid in deducing VCov(Q,A). A node u of subgraph query Q is in VCov(Q,A) when and only when either:

there exists O→(l,N) in A and ƒ_{Q}(u)=l; or

V̅_{S}^{u} [symbol] (u,N) and there exists a S-labeled set of subgraph query Q that is a subset of V̅_{S}^{u}∩VCov(Q,A).

When VCov(Q,A) is determined, E_{Q}⊂ECov(Q,A) is determined by definition and using the actualized constraints, without explicitly computing ECov(Q,A), in an embodiment.

Further details of method 500 are described below.

Auxiliary Structures.

Method 500 uses three auxiliary structures in an embodiment.

(1) Method 500 maintains a set B of nodes in subgraph query Q that are in VCov(Q,A) but it remains to be determined whether other nodes can be deduced from them. Initially, set B of nodes includes nodes whose labels are covered by type (1) constraints in A (line 3). Method 500 uses set B of nodes to control the while loop (lines 5-10). Method 500 terminates when B=Ø, i.e., all candidates for VCov(Q,A) are determined.

(2) For each node v, method 500 uses an inverted index L[v] to store all actualized constraints V̅_{S}^{u} [symbol] (u,N) such that VεV_{S}^{u}. In other words, L[v] indexes these constraints that can be used on node v.

(3) For each actualized constraint φ=V̅_{S}^{u} [symbol] (u,N), method 500 maintains a set ct[φ] to keep track of those labels of S that are not covered by nodes in V̅_{S}^{u}∩VCov(Q,A) yet. Initially, ct[φ]=S. When ct[φ] is empty, method 500 concludes that there is a S-labeled subset of V̅_{S}^{u} covered by VCov(Q,A), and thus deduces that node u should also be in VCov(Q,A) (line 10).

Using these auxiliary structures, method 500 includes the following two steps in an embodiment.

(1) Computing Γ finds all actualized constraints of A on subgraph query Q and puts them in Γ (lines 1-2). In an embodiment, this is accomplished by scanning or inspecting all nodes of subgraph query Q and their neighbors for each access constraint in A. In an embodiment, there are at most ∥A∥|V_{Q}| actualized constraints in Γ, i.e., Γ is bounded by O(∥A∥|E|).

(2) Computing VCov(Q,A), stored in a variable C. After initializing auxiliary structures as described above via procedure or function InitAuxi (lines 3-5 in FIG. 5a and FIG. 5b in an embodiment), method 500 processes nodes in B one by one (lines 6-11). For each uεB and each actualized constraint φ=V̅_{S}^{u} [symbol] (v,N) in L[u], it updates the set ct[φ] by removing label ƒ_{Q}(u) by procedure or function Update (line 9 in FIG. 5a and FIG. 5b in an embodiment). When ct[φ]=0, i.e., there exists a S-labeled subset in V̅_{S}^{v} that is covered by C, method 500 adds u to C and B (lines 10-11). When B is empty, i.e., all nodes have been inspected, method 500 determines whether V_{Q}⊂VCov(Q,A) and whether all edges are covered by ECov(Q,A). It returns “yes” when so (lines 12-13).

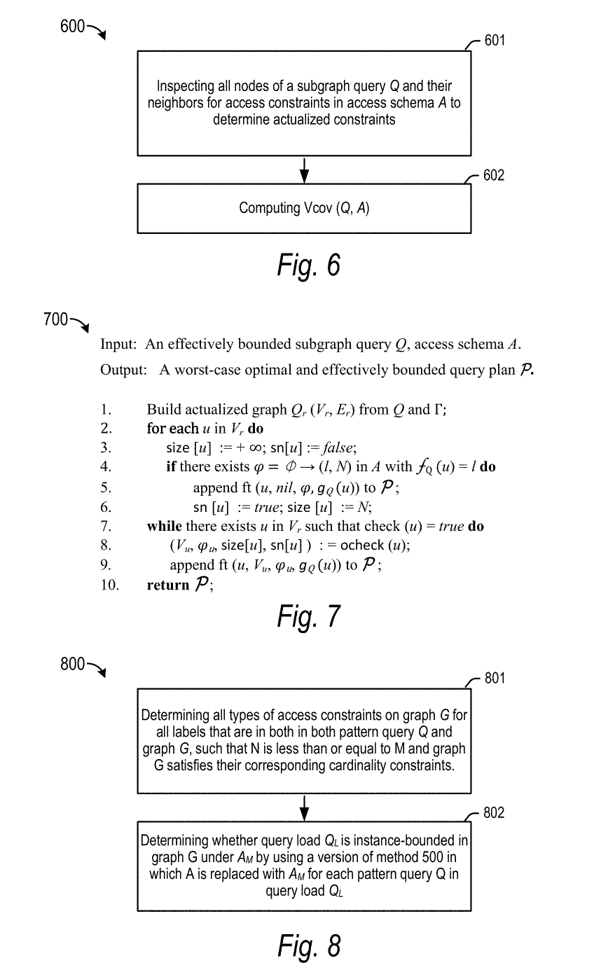

FIG. 6 is a flowchart that illustrates a method 600 to determine whether a subgraph query is effectively bounded according to embodiments of the present technology. In an embodiment, determine effectively bounded 1603, as shown in FIG. 16, executed by one or more processors, such as processor 1510 shown in FIG. 15, performs at least a portion method 600 in an embodiment.

Logic block 601 illustrates inspecting all nodes of a subgraph query Q and their neighbors for access constraints in access schema A to determine actualized constraints. In an embodiment, logic block 601 determines actualized constraints and stores them in a set of actualized constraints.

Logic block 602 illustrates computing Vcov(Q, A). In an embodiment, logic block 602 processes nodes one by one and uses each access constrain in the set of stored actualized constraints to determined covered nodes.

In a fifth example, for a subgraph query Q₀ of FIG. 2 and access schema A₀ in the second example, method 500 first computes the set Γ of actualized constraints: φ₁=(u₁,u₂) [symbol] (u₃,4), φ₂=u₃ [symbol] (u₄/u₅,30), and φ₃=u₄/u₅ [symbol] (u₆,1). Method 500 then sets both B and C to be {u₁, u₂, u₆}, and initializes ct[φ₁], . . . , ct[φ₃] and lists L[u₁], . . . , L[u₆] accordingly. Method 500 then pops nodes u₁ and u₂ off from set B and finds that u₃ can be deduced. Method 500 then adds node u₃ to sets B and C. Method 500 then pops node u₃ off from set B, processes nodes u₄ and u₅, and confirms that nodes u₄ and u₅ should be included in set C. At this point, method 500 finds that set C contains all the nodes in subgraph query Q₀ and moreover, each edge in subgraph query Q₀ is also covered by at least one access constraint in A₀. Thus it returns “yes”.

Correctness & Complexity.

The correctness of method 500 follows from above and the properties of actualized constraints stated above. Time complexity of method 500 is described below.

(1) General Case.

(a) Computing Γ is in O(|A∥E_{Q}|) time, since for each φ in A, all actualized constraints of φ may be found in O(Σ_{vεV}_{_{Q}}deg(v)|φ|)=O(|φ∥E_{Q}|) time, where deg(v) is the number of neighbors of v. (b) Computing VCov(Q,A) takes O(∥A∥|V_{Q}|²) time. For each φ in A, the sets ct(φ) for all corresponding actualized constraints φ in Γ are updated in time O(Σ_{vεV}_{_{Q}}(deg(v)²))=O(|V_{Q}|²). As each φ in Γ is processed once, the total time is bounded by O(∥A∥|V_{Q}|²). (c) The checking of lines 12-13 takes O(|A∥E_{Q}|+|V_{Q}|²) time. Thus, method 500 takes O(|A∥E_{Q}|+∥A∥|V_{Q}|²+|V_{Q}|²)=O(|A∥E_{Q}|+∥A∥|V_{Q}|²) time.

(2) Special cases. Method 500 may be optimized to O(|A∥E_{Q}|+|V_{Q}|²) time for each of the two special cases provided above in an embodiment. A counter n[φ] is used instead of ct[φ] in method 500 such that n[φ] always equals |ct[φ]| in an embodiment. Correctness is not affected since in the special cases, each time when ct[φ] is updated, a distinct label is removed. With an additional auxiliary structure, step (b) described above is in O(∥A∥|E_{Q}|) time in total since the counters are updated O(∥A∥(Σ_{vεV}_{_{Q}}deg(v)))=O(∥A∥|E_{Q}|) times in total, and each updates takes O(1) time: it just decreases n[φ] by 1.

### Generating Query Plans

After a pattern query Q(V_{Q},E_{Q}) is determined effectively bounded under an access schema A, a “good” query plan for pattern query Q is generated that, for any graph G, computes Q(G) by fetching a small subgraph G_{Q} such that Q(G)=Q(G_{Q}) and |G_{Q}| is determined by pattern query Q and A, independent of |G|.

The following are described below:

a worst-case optimality for query plans; and

a method to generate worst-case-optimal query plans in O(|V_{Q}∥E_{Q}∥A|) time.

Query plans are formalized and worst-case optimality described in detail below.

Query plans. In an embodiment, a query plan P for pattern query Q under A is a sequence of node fetching operations of the form ft(u, V_{S}, φ, g_{Q}(u)), where u is a l-labeled node in pattern query Q, V_{S} denotes a S-labeled set of pattern query Q, φ is a constraint φ=S→(l,N) in A, and g_{Q}(u) is the predicate of node u.

On a graph G, the operation is to retrieve a set cmat(u) of candidate matches for node u from graph G. For V_{S} that was retrieved from graph G earlier, it fetches common neighbors of V_{S} from graph G that: (i) are labeled with l, and (ii) satisfy the predicate g_{Q}(u) of node u. These nodes are fetched by using the index of φ and are stored in cmat(u). In particular, when S=Ø, the operation fetches all l-labeled nodes in graph G as cmat(u) for node u.

In an embodiment, operations ft₁ft₂ . . . ftₙ in query plan P are executed one by one, in this order. There may be multiple operations for the same node u in query pattern Q, each fetching a set Vᵢ^{u} of candidates for node u from graph G. To ensure that for ftᵢ and ftⱼ for node u, Vⱼ^{u} has less nodes than Vᵢ^{u} when i<j, and ft₁ reduces cmat(u) fetched by ftᵢ. Vₖ^{u} is denoted by Vᵤ, where ftₖ is the last operation for node u in query plan P, i.e., it fetches the smallest cmat(u) for node u.

Building Subgraph G_{Q}.

In other words, query plan P indicates what nodes to retrieve from graph G in an embodiment. From the data fetched by query plan P, a subgraph G_{Q}(V_{P},E_{P}) is built and used to compute Q(G) in an embodiment. More specifically, (a) V_{P}=∪_{uεQ}Vᵤ, i.e., it contains maximally reduced cmat(u) for each node u in pattern query Q; and (b) E_{P} consists of the following: for each node pairs (v,v′) in Vᵤ×V_{u′}, when (u,u′) is an edge in pattern query Q, a determination is made whether (v,v′) is an edge in G and when so, include it in E_{P}. This is done by accessing a bounded amount of data: φ_{u′}=S→(ƒ_{Q}(u′),N) in A and a S-labeled set Vₛ such that vεV_{S} is first determined. Common neighbors of V_{S} are fetched by using the index of φ_{u′} and determine whether v′ is one of them. As pattern query Q is effectively bounded under A (i.e., ECov(Q,A)=E_{Q}), when (v,v′) is an edge in graph G then such φ_{u′} and V_{S} exist.

Bounded Query Plans.

A query plan P for pattern query Q under A is effectively bounded when for all G|=A, query plan P builds a subgraph G_{Q} of graph G such that: (a) Q(G_{Q})=Q(G), and (b) the time for fetching data from graph G by all operations in query plan P depends on A and pattern query Q only in an embodiment. In other words, query plan P fetches a bounded amount of data from graph G and builds subgraph G_{Q} from graph G. By (b), |G_{Q}| is independent of |G| in an embodiment.

Optimality. An optimal query plan P that determines a minimum subgraph G_{Q} may be preferred, i.e., for each graph G|=A, subgraph G_{Q} identified by query plan P has the smallest size among all subgraphs identified by any effectively bounded query plans. However, in an embodiment, there exists no query plan that is both effectively bounded and optimal for all graphs G|=A.

Accordingly, an effectively-bounded query plan P for pattern query Q under A is worst-case optimal when for any other effectively bounded query plan PI for pattern query Q under A,

$${max}_{G \vert = A} \vert {G}_{Q} \vert \leq {max}_{G \vert = A} \vert {G}_{Q}^{′} \vert$$

where G_{Q} and G′_{Q} are subgraphs identified by P and P′, respectively.

In other words, for any pattern query Q and A, for all G|=A, the largest subgraph G_{Q} identified by query plan P is no larger than the worst-case subgraphs identified by any other effectively bounded query plans.

Worst-case optimal query plans are described in detail below.

In an embodiment, there exists a method that, for any effectively bounded subgraph query Q under an access schema A, determines a query plan that is both effectively bounded and worst-case optimal for subgraph query Q under A, in O(|V_{Q}∥E_{Q}∥A|) time.

FIG. 7 is a flowchart that illustrates a method 700 to determine a worst-case optimal query plan according to embodiments of the present technology. Method 700 is also referred to as method QPlan unless the contents indicates otherwise. In an embodiment, method 700 is represented by psuedocode that may represent non-transitory instructions executed by one or more processors in an embodiment

In an embodiment, method 700 inspects each node u of a pattern query Q, determines an access constraint φ in A such that an index in the access constrain enables retrieval of candidates cmat(u) for node u from an input graph G, generates a fetching operation accordingly, and stores the fetching operation in a list of query plan P. Method 700 then iteratively reduces cmat(u) for each node u in pattern query Q to optimize query plan P, until query plan P cannot be further improved.

In an embodiment, method 700 may use the following structures:

(1) An actualized graph Q_{Γ}(V_{Γ},E_{Γ}), which is a directed graph constructed from pattern query Q and the set Γ of all actualized constraints of A on pattern query Q as described herein. In particular, (a) V_{Γ}=V_{Q}; and (b) for any two nodes u₁ and u₂ in V_{Γ}, (u₁,u₂) is in E_{Γ} when there exists a constraint V̅_{S} [symbol] (u₂,N) in Γ such that u₁ is in V̅_{S}. In other words, Q_{Γ} represents deduction relations for nodes in V_{Q}, and guides to extract candidate matches for pattern query Q.

(2) For each node u in pattern query Q, a counter size[u] to store the cardinality of cmat(u), and a Boolean flag sn[u] to indicate whether the fetching operations in a current query plan P may determine cmat(u).

In an embodiment, method 700 first builds actualized graph Q_{Γ} (line 1), and initializes size[u]=+∞ and sn[u]=false for all the nodes u in Q_{Γ} (lines 2-3). Method 700 then determines nodes u₀ for which cmat(u) may be retrieved by using the index specified in some type (1) constraints Ø→(l,N) in A (lines 4-6). For each node u₀, method 700 adds a fetching operation to query plan P and sets sn[u₀]=true and size[u₀]=N.

After the initialization, method 700 recursively processes nodes u of pattern query Q to retrieve or reduce their cmat(u) (lines 7-9), starting from those nodes u₀ identified in line 4. Method 700 picks the next node u by a function check. In particular, check(u) does the following in an embodiment: (i) determines the set Vᵤ^{p} of parents of node u in Q_{Γ} such that sn[v]=true for all vεVᵤ^{p}, (ii) selects a subset Vᵤ of Vᵤ^{p} such that Vᵤ forms a S-labeled set for some constraint φᵤ=S→(ƒ_{Q}(u),N) in A, and moreover, N*Π_{vεV}_{ᵤ}size[v] is minimum among all such S-labeled sets of node u; and (iii) returns true when N*Π_{vεV}_{ᵤ}size[v]<size[u]. When check(u)=true, method 700 sets size[u]=N*Π_{vεV}_{ᵤ}size[v] and sn(u)=true by function ocheck, and adds a fetching operation to query plan P for node u using φᵤ and Vᵤ. Method proceeds until for no node u in pattern query Q, check(u)=true (line 7). At this point, method 700 returns query plan P (line 10).

In a sixth example, for a pattern query Q₀ of FIG. 2 and access schema A₀ of the second example, method 700 determines a query plan P as follows in an embodiment. Using the actualized constraints Γ of A₀ on pattern query Q₀ (see third example), method 700 first builds Q_{Γ}, which is the same as pattern query Q₀ except the directions of the edges (u₃,u₁) and (u₃,u₂) are reversed. Using type (1) constraints in A₀, method 700 adds ft₁(u₁, nil, φ₅, true), ft₂ (u₂, nil, φ₄, year≧2011 [symbol] year≦2013) and ft₃ (u₆, nil, φ₆, true) to query plan P. In the while loop, method 700 determines check (u₃)=true and adds ft₄ (u₃, {u₁, u₂}, φ₁, true) to query plan P. As a consequence of ft₄, method 700 determines that check (u₄) and check (u₅) become true and thus adds ft₅(u₄, {u₃}, φ₂, true) and ft₆(u₅, {u₄}, φ₂, true) to query plan P. Query plan P cannot be further improved in an embodiment, and method 700 returns query plan P with 6 fetching operations.

How query plan P identifies subgraph G_{Q} from the IMDb graph G₀ of the first example for pattern query Q₀ is described. (a) Query plan P executes its fetching operations one by one, and retrieves cmat(u) from graph G₀ for u ranging over u₁−u₆, with at most 24, 3, 288, 8640, 8640 and 196 nodes, respectively. These are treated as the nodes of subgraph G_{Q}, no more than 17791 in total. (b) Query plan P then adds edges to subgraph G_{Q}. For each (v₃,v₁)εcmat(u₃)×cmat(u₁), query plan P determines whether (v₃,v₁) is an edge in graph G₀ by using cmat(u₁), cmat(u₂) and cmat(u₃), and the index of φ₁ of A₀, as suggested by fetching operation ft₄ for node u₃ as described above. When so, (v₃,v₁) is included in subgraph G_{Q}. This determines 24×3×4 neighbors of cmat(u₃) in the worst case. Similarly, it examines at most 288, 8640, 8640, 8640 and 8640 candidates matches in graph G₀ for edges (u₃,u₂), (u₃,u₄), (u₃,u₅), (u₄,u₆) and (u₄,u₆) in pattern query Q₀, respectively. This yields at most 34,848 edges in subgraph G_{Q} in total in an embodiment. In an embodiment, query plan P is the one described in the first example, and accesses at most 17,923 nodes and 35,136 edges in total. In an embodiment, only part of the data accessed by query plan P is included in subgraph G_{Q} for answering pattern query Q₀.

Correctness & Complexity.

For the correctness of method 700, the following may be observed about the query plan P generated for pattern query Q and A. (1) Query plan P is effectively bounded: in particular, (a) the total amount of data fetched by query plan P is decided by A and pattern query Q since query plan P only uses indices in A to retrieve data in an embodiment; and (b) Q(G_{Q})=Q(G) since subgraph G_{Q} includes all candidate matches from graph G for nodes and edges in pattern query Q. By the data locality of subgraph queries, when a node v in graph G matches a node u in pattern query Q, then for any neighbor u′ of u in pattern query Q, matches of u′ must be neighbors of v in graph G. That is why cmat(u) collects candidate node matches from neighbors; similarly for edges in an embodiment. (2) query plan P is worst-case optimal in an embodiment: since the while loop in method 700 reduces cmat(u) to be the minimum.

To see that method 700 is in O(|V_{Q}∥E_{Q}∥A|) time, observe the following. (1) Line 1 is in O(|A∥E_{Q}|) time. (2) The for loop (lines 2-6) is in O(|V_{Q}|) time by using the inverted indices. (3) The while loop (lines 7-9) iterates |V_{Q}|² times, since for each node u in pattern query Q, (a) cmat(u) is reduced only when cmat(u′) is reduced for its “ancestors” u′ in Q_{Γ}, |V_{Q}|−1 times at most, by the definition of size[u] and check (i.e., size[u] remains larger than size[u′]), and (b) each reduction to cmat(u′) requires determination whether cmat(u) is also reduced as a consequence in an embodiment. In each iteration, check(u) and ocheck(u) take O(deg(u)|A|) time. As O(|V_{Q}|*Σ_{uεV}_{_{Q}}deg(u)|A|)=O(|V_{Q}∥E_{Q}∥A|), the while loop takes O(|V_{Q}∥E_{Q}∥A|) time in total.

### Making Pattern Queries Instance-Bounded

A frequent query load Q, such as a finite set of parameterized pattern queries, may be used in recommendation systems in an embodiment. When some pattern queries Q in query load Q are not effectively bounded under an access schema A, Q(G) in a graph G may still be computed. Often, as described below, some pattern queries in query load Q may be made instance-bounded in graph G and an answer may be provided from graph G by accessing a bounded amount of graph data.

Extending Access Schemas.

Access schema A is extended such that indices of the access schema A suffice to aid in fetching bounded subgraphs of graph G for answering a query load Q. For example, consider a constant M. An M-bounded extension A_{M} of A includes all access constraints in A and additional access constraints of types (1) and (2) as described above:
Type (1): →(l′,N)
Type (2): l→(l′,N)

such that N≦M. Note that A_{M} is also an access schema in an embodiment.

Instance-Bounded Pattern Queries.

In particular, G|=A_{M}. In an embodiment, a set of pattern queries or query load Q is instance-bounded in graph G under A_{M} when for all QεQ, there exists a subgraph G_{Q} of graph G such that:

(a) Q(G_{Q})=Q(G); and

(b) G_{Q} can be found in time determined by A_{M} and Q only.

As a result of (b) and the use of constant M, |G_{Q}| is a function of A, pattern query Q and natural number M. As opposed to effective boundedness, instance-boundedness aims to process a finite set of pattern queries in query load Q on a particular instance of graph G by accessing a bounded amount of data.

In other words, an answer to a query load Q in a graph G is obtained as follows. When some queries in query load Q are not effectively bounded under A, A is extend to A_{M} by adding access constraints such that all queries in query load Q are instance-bounded in graph G under A_{M}.

Bounded Extension Proposition:

For any query load Q including a finite set of subgraph queries, access schema A and graph G|=A, there exist M and an M-bounded extension A_{M} under which query load Q is instance-bounded in graph G.

In other words, additional access constraints of types (1) and (2) suffice to make a query load Q instance-bounded in graph G. In an embodiment, A_{M} extends A with at most

$$\frac{{L}_{Q} ( {L}_{Q} + 1 )}{2}$$

additional constraints, where L_{Q} is the total number of labels in query load Q.

Resource-Bounded Extensions.

Bounded extension proposition above always holds when M is sufficiently large in an embodiment. When M is a small predefined bound indicating constrained resources, the following question, denoted by EEP(Q, A, M, G), is answered:

Input: Query load Q including finite set of subgraph queries, an access schema A, a natural number M, and a graph G|=A.

Question: Does there exist a M-bounded extension A_{M} of A such that query load Q is instance-bounded in graph G under A_{M}?

This problem is decidable in PTIME in an embodiment.

EEP(Q, A, M, G) is in O(|G|+(|A|+|Q|)|E_{Q}|+(∥A∥+|Q|)|V_{Q}|²) time, where |G/=/V|+|E|, |E_{Q}|=Σ_{QεQ}|E_{Q}|, |V_{Q}|=Σ_{QεQ}|V_{Q}| and |Q|=|E_{Q}|+|V_{Q}|.

For a frequent query load Q, A_{M} is identified. When A_{M} exists, additional indices on graph G are built and make G|=A_{M}, as preprocessing offline. Query templates of frequent query load Q are repeatedly instantiated and processed by accessing a bounded amount of data in graph G, and indices are incrementally processed in response to changes to graph G. Pattern queries Q in frequent query load Q may be small in embodiments.

FIG. 8 illustrates a method 800 to determine whether there exist a M-bounded extension A_{M} of A such that query load Q is instance-bounded in graph G under A_{M} according to embodiments of the present technology. Method 800 is also referred to as method EEChk unless the contents indicates otherwise. In an embodiment, make pattern query bounded, as shown in FIG. 16, executed by one or more processors, such as processor 1510 shown in FIG. 15, performs at least a portion method 800 in an embodiment.

In particular, logic block 801 illustrates (Maximum M-bounded extension): Determine all types (1) and (2) access constraints Ø→(l′,N) and l→(l′,N) on graph G for all labels l and (l,l′) that are in both query pattern Q and graph G, such that N≦M and graph G satisfies their corresponding cardinality constraints. A_{M} include all these constraints and all those in A in an embodiment.

Logic block 802 illustrates (Determine): Determine whether query load Q is instance-bounded in graph G under A_{M} by using a version of method 500 in which A is replaced with A_{M} for each QεQ; return “yes” when method 500 returns “yes” for all pattern queries Q in query load Q, and “no” otherwise.

In a seventh example, consider a particular bound M=150, the IMDb graph G₀ of the first example, query load Q with only pattern query Q₀ of FIG. 2, and an access schema A consisting of all access constraints in A₀ of the second example except φ₄ and φ₅. In the seventh example, method 800 determines a M-bounded extension A_{M} of A. (1) As illustrated by logic block 801, method 800 determines, among other functions, that graph G satisfies the cardinality constraints of two type 1 access constraints φ₄=Ø→(year,135) and φ₅=Ø→(award, 24), and 135<M and 24<M. As illustrated by logic block 801, method 800 extends A by including φ₄ and φ₅, yielding A_{M}. (2) Method 800, in particular logic block 802, then invokes method 500 replacing A with A_{M} and confirms that query load Q with only pattern query Q₀ is instance-bounded in graph G under A_{M}.

Correctness & Complexity.

A correctness of method 800 (or method EEChk) may be ensured by the following. (1) When there exists A′_{M} such that query load Q is instance-bounded in graph G under A′_{M}, then query load Q is instance-bounded in graph G under A_{M} for A′_{M}⊂A_{M}; hence it suffices to consider the maximum M-bounded extension A_{M} of A. (2) Determining instance-boundedness is a version of method 500 with replacing A with A_{M}, with the same complexity as described above.

For the complexity, observe that step (1) or logic block 801 of method 800 is in O(|G|) time, |A_{M}| and ∥A_{M}∥ are bounded by |A|+|Q| and ∥A∥+|Q|, respectively. Step (2) or logic block 802 takes O((|A|+|Q|)|E_{Q}|+(∥A∥+|Q|)|V_{Q}|²) time by the complexity of method 500.

A minimum M-extension A_{M} of A such that query load Q is instance-bounded under A_{M}, and A_{M} has the least number of access constraints among all M-extensions of A that make query load Q instance-bounded in graph G may be difficult to determine. In an embodiment, it is log APX-hard to determine such a minimum M-extension for a particular set of query load Q, A, M and G. Here log APX-hard problems are NP optimization problems for which no PTIME methods have approximation ratio below clog n, where c is some constant and n is the input size.

### Effectively Bounded Simulation Pattern Queries

Effective boundedness aids in answering subgraph queries in big graphs within constrained resources as well as simulation pattern queries, which may be non-localized and recursive.

The following description of effectively bounded simulation pattern queries includes (1) a characterization; (2) a determination method; and (3) a method for generating effectively bounded and worst-case optimal query plans, all with the same complexity as their counterparts for subgraph pattern queries. The following description also includes (4) a method for making a finite set of unbounded simulation pattern queries instance-bounded. In an embodiment, effective-boundedness, as described below, operates with general pattern queries, localized or non-localized in an embodiment.

Characterization for Simulation Pattern Queries.

Determining answers to simulation pattern queries may require slightly different methods than used with pattern queries.

In an eighth example, a simulation pattern query Q₁(V₁,E₂) of the second example is used along with an access schema A₁ with φ_{A}=B→(A,2), φ_{B}=CD→(B,2), φ_{C}=Ø→(C,1), and φ_{D}=Ø→(D,1). VCov(Q₁,A₁)=V₁ and ECov(Q₁,A₁)=E₁ are verified. However, simulation pattern query Q₁ is not effectively bounded. In particular, graph G₁ of FIG. 4 matches simulation pattern query Q₁, and the maximum match relation Q₁(G₁) “covers” a cycle in graph G₁ with length proportional to |G₁|. In other words, while A₁ constrains the neighbors of each node in simulation pattern query Q₁, it does not suffice. As shown in the second example, to determine whether node V₁ of graph G₁ matches node u₁ of simulation pattern query Q₁, nodes of graph G₁ need to be inspected far beyond the neighbors of node v₁, due to the non-localized and recursive nature of simulation pattern queries in embodiments.

Accordingly, a stronger method of node covers may be used in an embodiment. The node cover of an access schema A on a simulation pattern query Q, denoted by sVCov(Q,A), is the set of nodes in simulation pattern query Q computed as follows:

(a) when a type (1) constraint Ø→(l,N) is in A, then for each node u in simulation pattern query Q with label l, uεsVCov(Q,A); and

(b) when S→(l,N) is in A, then for each S-labeled set V_{S} in simulation pattern query Q, a common neighbor node u of V_{S} in simulation pattern query Q is in sVCov(Q,A) when (i) node u is labeled with l, (ii) V_{S}⊂sVCov(Q,A) and (iii) for each node u_{S} in V_{S}, (u,u_{S}) is an edge of simulation pattern query Q.

As opposed to VCov for subgraph queries, a node u is in sVCov(Q,A) when in any graph G|=A, the number of candidate matches of node u is bounded in graph G, no matter whether these nodes are in the same neighborhood or not. Node u is included in sVCov(Q,A) only when some of its children are covered by A and they bound the candidate matches of node u by an access constraint. When V_{Q}=sVCov(Q,A) is enforced as described below, this ensures that all children of node u have a bounded number of candidates in graph G. This rules out unbounded matches when retrieving maximum matches by using the indices of A.

The edge cover of A on simulated pattern query Q, denoted by sECov(Q,A), is defined in the same way as ECov(Q,A) for subgraph queries as described above, using sVCov(Q,A) instead of VCov(Q,A).

Covers for simulation pattern queries are more restrictive than their counterparts for subgraph queries: sVCov(Q,A)⊂VCov(Q,A)⊂V_{Q} and sECov(Q,A)⊂ECov(Q,A)⊂E_{Q}.

A simulation pattern query Q(V_{Q},E_{Q}) is effectively bounded under an access schema A when and only when V_{Q}=sVCov(Q,A) and E_{Q}=sECov(Q,A) in an embodiment.

In a ninth example, recall simulation pattern query Q₁ and A₁ from the eighth example above. Neither node u₁ nor node u₂ in simulation pattern query Q₁ is in sVCov(Q₁,A₁) and hence, simulation pattern query Q₁ is not effectively bounded under A₁.

Now define Q₂(V₂, E₂) by reversing the directions of (u₃, u₂) and (u₄, u₂) in simulation pattern query Q₁. Then sVCov(Q₂, A₁)=V₂ and sECOV(Q₂, A₁)=E₂. Accordingly, simulation pattern query Q₂ is effectively bounded under A₁. For graph G₁ of FIG. 4, Q₂(G₁)= may be determined without fetching the unbounded cycle of graph G₁.

Deciding Effective Boundedness of Simulation Pattern Queries.

As described below, EBnd(Q,A) has the same complexity as for subgraph queries, in both the general case and the two special cases described above.

In particular, a method to determine whether a simulated pattern query is effectively bounded under A is denoted as an sEBChk method. In an embodiment, a sEBChk method is the same as method 500 (EBChk method) of FIG. 5 except that sEBChk method uses a revised use of actualized constraints. For each S→(l,N) in A with S≠Ø, and each node u in simulation pattern query Q with ƒ_{Q}(u)=l, its actualized constraint for simulation is V̅_{S}^{u} [symbol] (u,N), where V̅_{S}^{u} is the maximum set of neighbors of node u in simulation pattern query Q such that (a) there exists a S-labeled set V_{S}⊂V̅_{S}^{u}, and (b) for each u′εV̅_{S}^{u}, ƒ_{Q}(u′)εS; and (ii) (u,u′) is an edge of simulation pattern query Q. In contrast to actualized constraints for pattern queries, simulated pattern queries requires condition (ii) to cope with sVCov(Q,A).

In a tenth example, for simulation pattern query Q₂(V₂,E₂) and A₁ in the ninth example above, sEBChk method first computes the set Γ of actualized constraints for A₁ on simulation pattern query Q₂: φ₁=(u₃,u₄) [symbol] (u₂,2), φ₂=u₂ [symbol] (u₁,2). The sEBChk method then initializes both B and C to be {u₃, u₄}, sets ct[φ₁]=2, ct[φ₂]=1, and initializes lists L[u₁], . . . , L[u₄] accordingly as shown in FIG. 5. As in the fifth example, sEBChk method determines that V₂⊂C and that each edge of E₂ is covered by some constraint in A₁. Thus it returns “yes”, i.e., simulation pattern query Q₂ is effectively bounded under A₁.

The correctness of a sEBChk method follows from the above characterization. Along the same lines as the correctness of a EBChk method, the following property of sVCov(Q,A) is used: a node u of simulation pattern query Q is in sVCov(Q,A) when and only when either:

there exists Ø→(l,N) in A and ƒ_{Q}(u)=l; or

V̅_{S}^{u} [symbol] (u,N) and there exists a S-labeled set of simulation pattern query Q that is a subset of V̅_{S}^{u}∩sVCov(Q,A).

A sEBChk method has the same complexity as a EBChk method. The sEBChk method is the same as EBChk method except the computation of the set Γ of all actualized constraints (lines 1-2 of FIG. 5), which remains in O(|A∥E_{Q}|) time, the same as for subgraph queries.

Generating Effectively Bounded Query Plans.

For effectively bounded simulation pattern queries Q under an access schema A, query plans P may be generated such that in any graph G, query plan P computes Q(G) by accessing a bounded subgraph G_{Q} of simulation pattern query Q, leveraging the indices of A, such that Q(G)=Q(G_{Q}). In particular, forming query plans for subgraph queries may be used for simulation pattern queries.

There exists a method that, for any effectively bounded simulation pattern query Q under an access schema A, generates an effectively bounded and worst-case optimal query plan in O(|V_{Q}∥E_{Q}∥A|) time in an embodiment.

A method sQPlan, similar to the method QPlan shown in FIG. 7, determines a query plan for effectively bounded simulation pattern queries. In an embodiment, method sQPlan retains the same complexity as method QPlan. In an embodiment, the only difference between method sQPlan and method QPlan includes using actualized constraints for simulation as described above, and a stronger use of node covers is used instead of data locality.

In an eleventh example, for simulation pattern query Q₂(V₂,E₂) of the ninth example and A₁ of eighth example, method sQPlan generates a query plan P. Using the set Γ of actualized constraints of A₁ on simulated pattern query Q₂ (see tenth example), method sQPlan builds Q_{Γ}(V_{Γ},E_{Γ}), where V_{Γ}=V₂, and E_{Γ} contains (u₃,u₂), (u₄,u₂) and (u₂, u₁). Initially, method sQPlan adds ft(u₃, nil, φ_{C}, true) and ft(u₄, nil, φ_{D}, true) to query plan P. Method sQPlan then determines that u₂ and u₁ can be deduced from u₃ and u₄ by using Q_{Γ}, and thus adds ft(u₂, {u₃,u₄}, φ_{B}, true) and ft(u₁, {u₂}, φ_{A}, true) to query plan P.

For any graph G|=A, simulation pattern query Q₂(G) is computed by using query plan P. Query plan P retrieves eight candidate matches for nodes in simulation pattern query Q₂, i.e., four for u₁, two for u₂, and one for each of u₃ and u₄. Query plan P then determines at most twelve edges between these candidates that are possible edge matches by using the indices of A₁: four for each of (u₁,u₂) and (u₂,u₁), and two for each of (u₂,u₃) and (u₂,u₄). In other words, query plan P fetches a subgraph G_{Q}_{₂} of simulation pattern query Q₂, by accessing eight nodes and twelve edges.

Making Simulation Pattern Queries Instance-Bounded.

Making finite sets Q of simulation pattern queries effectively bounded under an access schema A is described below. As described above, for any graph G|=A, there exists an M-bounded extension A_{M} of A under which set Q of simulation pattern queries is instance-bounded in graph G for some bound M.

For a predefined and small M, EEP(Q, A, M, G), as described above, decides whether there exists an M-bounded extension A_{M} of A that makes sets Q of simulation pattern queries instance-bounded in graph G.

For simulation pattern queries, EEP(Q, A, M, G) is in O(|G|+(|A|+|Q|)|E_{Q}|+(∥A∥+|Q|)|V_{Q}|²) time.

A minor revision of method sEEChk of method EEChk determines EEP for simulation pattern queries, with the same complexity as EEChk.

### EXPERIMENTS

Using typical graph databases, three sets of experiments were conducted to evaluate: (1) effectiveness of a query based on effective boundedness, (2) effectiveness of instance-boundedness, and (3) efficiency of methods described herein.

Experiment Settings.

Three graph databases were used in the experiments:

(1) Internet Movie Data Graph (IMIDbG) was generated from the Internet Movie Database (IMDb) (http://www.imdb.com/stats/search/) having approximately 5.1 million nodes and 19.5 million edges with 168 labels in IMIDbG;

(2) Knowledge graph (DBpediaG) was taken from DBpedia 3.9 (http://wiki.dbpedia.org/Downloads39) having approximately 4.1 million nodes and 19.5 million edges with 1434 labels; and

(3) Webbase-2001 (WebBG) includes recorded Web pages produced in 2001 (http://law.di.unimi.it/webdata/webbase-2001/), in which nodes are URLs, edges are directed links between them, and labels are domain names of the URLs that includes approximately 118 million nodes and 1 billion edges with 0.18 million labels.

Access Schema.

168, 315 and 204 access constraints were determined from IMIDbG, DBpediaG and WebBG graph databases, respectively, by using degree bounds, label frequencies and data semantics. For example, (actress, year)→(feature_film, 104) is a constraint on IMIDbG graph database, stating that each actress starred in no more than 104 feature films per year. While access constraints from typical graph databases may be extracted as described herein, other access constraints may be used in other embodiments.

For each access constraint S→(l,N), an index is formed by (a) creating a table in which each tuple encodes an actualized constraint V_{S} [symbol] (u,N); and (b) forming an index on the attributes for V_{S} in the new table, using MyS 5.5.35 in an embodiment.

Graph Pattern Queries.

For each graph database, approximately 100 pattern queries were randomly generated using labels of the pattern queries, controlled by #n, #e, and #p, the number of nodes, number of edges, and matches predicates in the ranges [3, 7], [#n−1, 1.5*#n] and [2, 8], respectively. Graph pattern queries that are relatively large were not used so as to favor typical VF2 and optVF2 methods, which may not operate on pattern queries that are relatively large.

Methods.

The following methods were implemented in C++: (1) EBChk, QPlan, abdEEChk methods for subgraph queries, and sEBChk, sQPlan, sEEChk methods for simulation pattern queries; (2) pattern matching for bVF2 and bSim methods for subgraph and simulation pattern queries, by using query plans generated by QPlan and sQPlan methods, respectively; (3) typical matching methods gsim and VF2 (using C++ Boost Graph Library) for simulation pattern and subgraph queries, respectively, and their optimized versions optgsim and optVF2 by using indices in the access constraints.

Experiments were conducted on an Amazon EC2 memory optimized instance r3.4×large with 122 GB memory and 52 EC2 compute units. Experiments were run 3 times with the average described herein.

### Experimental Results

### First Experiment: Effectiveness of Effective Boundedness

(1) Percentage of Effectively Bounded Queries.

Randomly generatated pattern queries were determined to be effectively bounded using EBChk and sEBChk methods: (1) approximately 61%, 67% and 58% of subgraph queries on IMDbG, DBpediaG and WebBG graph databases are effectively bounded under the access constraints described above, and (2) approximately 32%, 41% and 33% for simulation pattern queries, respectively. This may indicate that (a) by using a relatively small number of access constraints, many subgraph and simulation pattern queries are effectively bounded; and (b) more subgraph queries are bounded than simulation queries under the same constraints, due to their locality.

(2) Effectiveness of Bounded Queries.

To evaluate the impact of effectively bounded queries, running time by bVF2 and bSim methods (with query plans generated by QPlan and sQPlan methods) were compared to VF2, optVF2 and gsim, optgsim methods. As VF2 and optVF2 methods are relatively slow, performance is reported when they ran to completion. Unless stated otherwise, all access constraints and full-size graph databases were used.

(a) Impact of |G|.

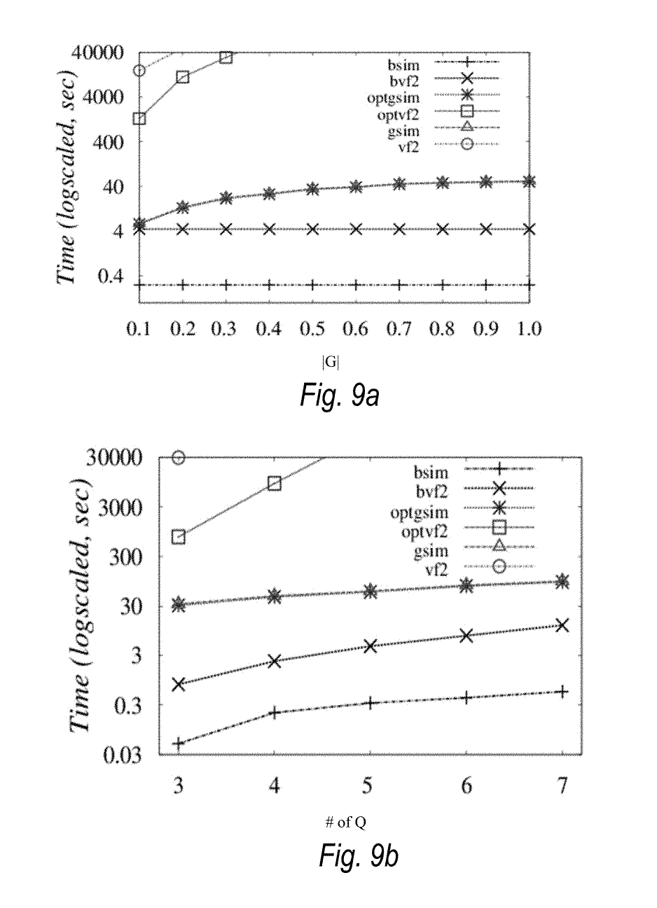

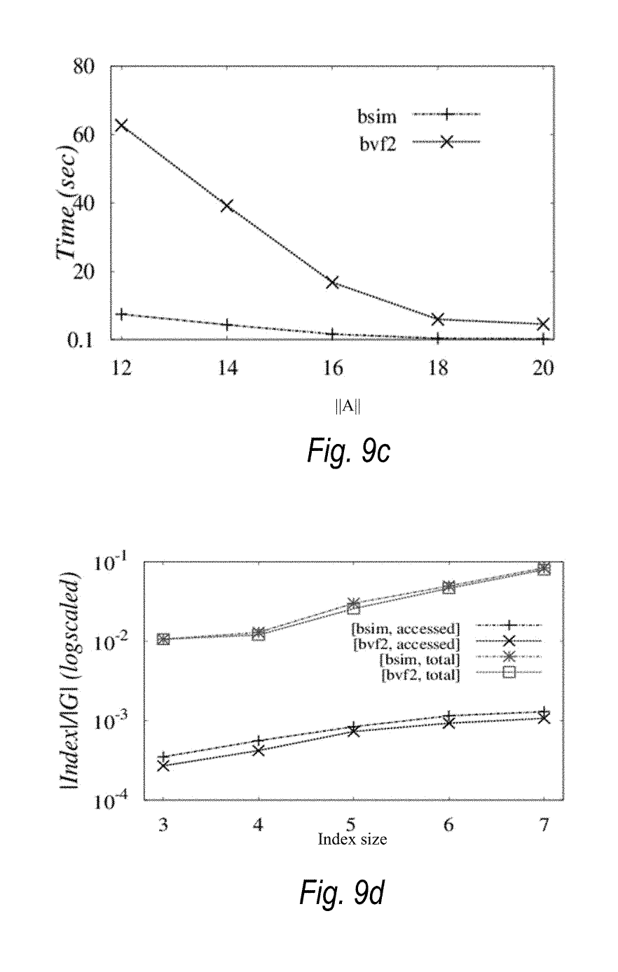

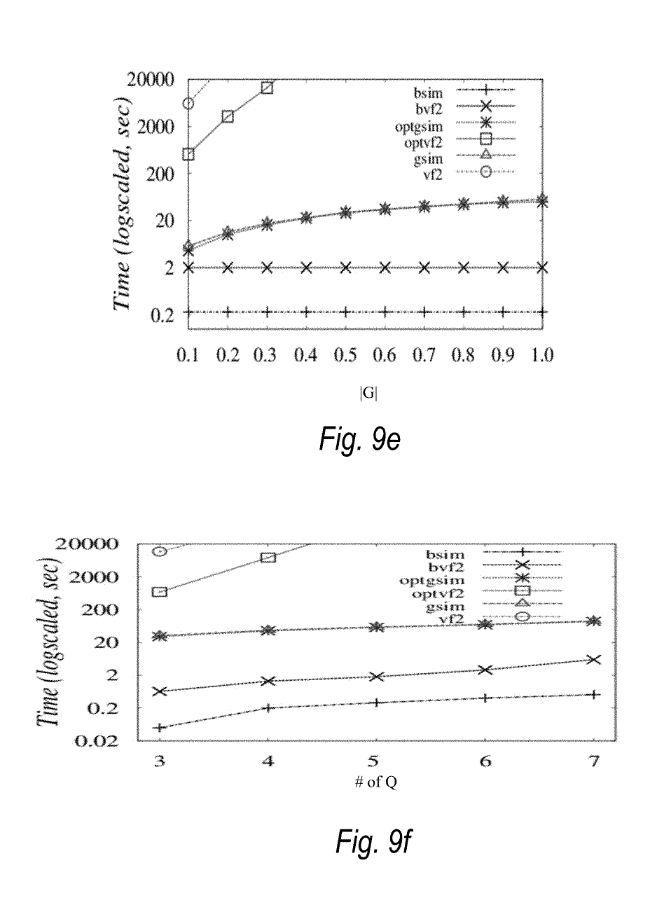

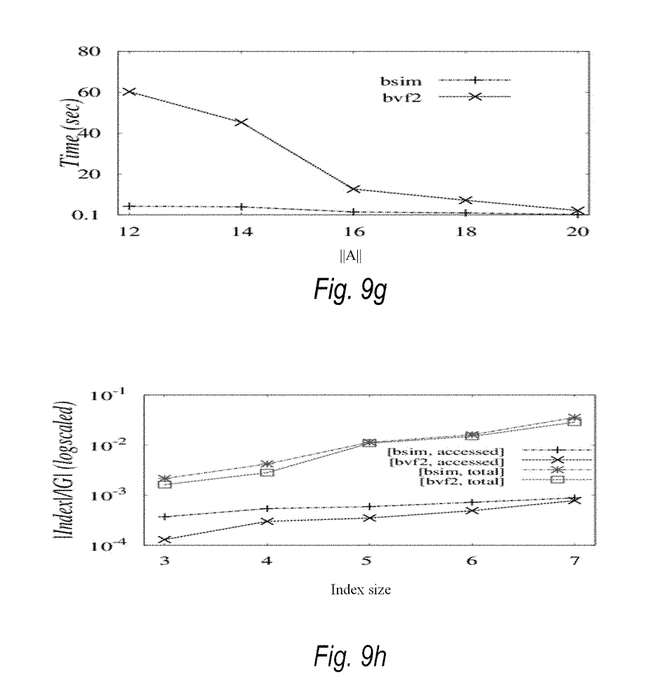

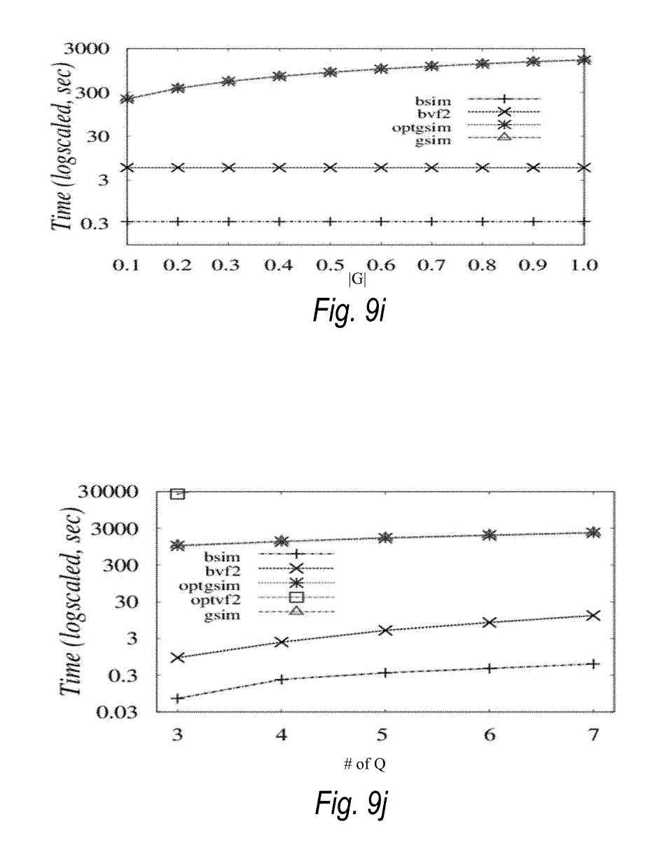

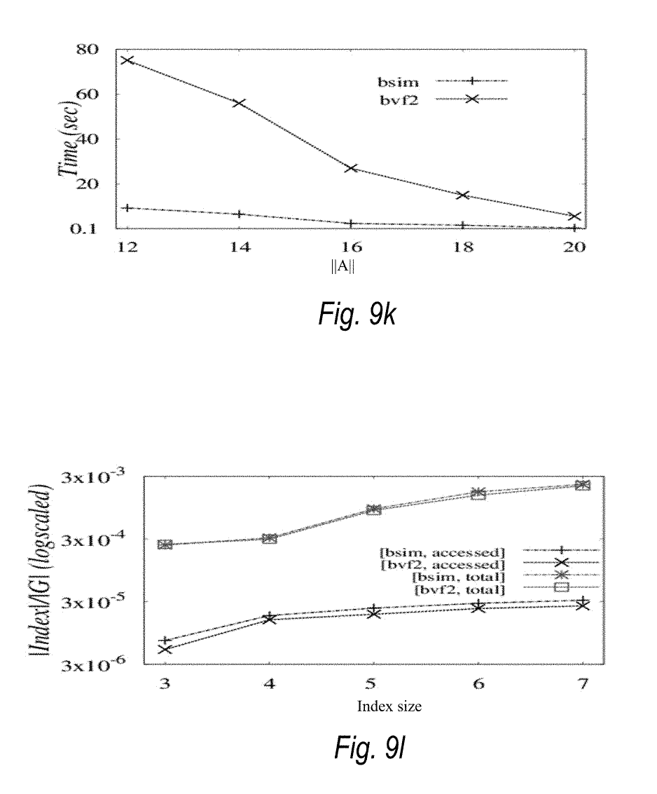

Varying the size |G| by using scale factors from 0.1 to 1, the results on the three graph databases are shown in FIGS. 9(a), 9(e) and 9(i). The results may indicate: (1) The evaluation time of effectively bounded queries is independent of |G|. In particular, bVF2 and bSim methods consistently took approximately 4.45 s, 2.02 s, 5.8 s and 0.25 s, 0.23 s, 0.34 s on all subgraphs of IMDbG, DBpediaG and WebBG graph databases, respectively. (2) VF2 and optVF2 methods could not run to completion within 40,000 s on all subgraphs of WebBG graph database and on subgraphs of IMDbG and DBpediaG graph databases with scale factors above approximately 0.3. On a full-size WebBG graph database, bVF2 methods took approximately 0.9 s as opposed to approximately 25,729 s by optVF2 method for pattern queries that optVF2 method could process within reasonable amount of time, at least 28,587 times faster. (3) Optgsim and gsim methods appear to be sensitive to |G| (note the logarithmic scale of the y-axis), and are much slower than bSim method. For example, on the full-size WebBG graph database, bSim method took 0.34 s vs. 1,630 s by optgsim method, 4793 times faster. An improvement of bVF2 method over optVF2 method is bigger than that of bSim method over optgsim method as optVF2 method has a higher complexity and thus, may be more sensitive to |G|.

(b) Impact of Q.

To evaluate an impact of pattern queries, #n of pattern query Q were varied from 3 to 7. The results, as shown in FIGS. 9(b), 9(f) and 9(j), that may indicate the following. (1) The smaller pattern query Q is, the faster all the methods are. (2) For all pattern queries, bVF2 and bSim methods are efficient: they return answers within approximately 12.7 s on all three graph databases. (3) VF2 and optVF2 methods do not scale with a pattern query Q. When #n>4, none of them could run to completion within 40,000 s, on all three graph databases. (4) Gsim and optgsim methods are much slower than bSim method for all pattern queries.

(c) Impact of ∥A∥.

To evaluate the impact of access constraints on bVF2 and bSim methods, ∥A∥ was varied from 12 to 20 and processed effectively bounded queries using the varied indices in A. As shown in FIGS. 9(d), 9(g) and 9(k), more access constraints aid QPlan and sQPlan methods to form better query plans. For example, on WebBG graph database when 20 access constraints were used, bSim and bVF2 methods took approximately 0.36 s and 5.6 s, respectively, while they were 9.3 s and 75.1 s when ∥A∥=12.

(3) Size of Accessed Data.

In the same setting as the First Experiment (2)(b) as above, the size of data accessed by bVF2 and bSim methods are examined. For each effectively bounded pattern query Q, the following was examined: (a) |accessed_{Q}|, the size of data accessed, and (b) |index_{Q}|, the size of indices in those access constraints used, by bVF2 and bSim methods for answering pattern query Q. The average is reported in FIGS. 9(d), 9(h) and 9(l). The results may indicate that the query plans accessed no more than approximately 0.13% of |G| for all subgraph and simulation pattern queries on all graph databases, with indices approximately less than 8% of |G|. These results further indicate the effectiveness of our technology.

### Second Experiment: Effectiveness of Instance-Boundedness

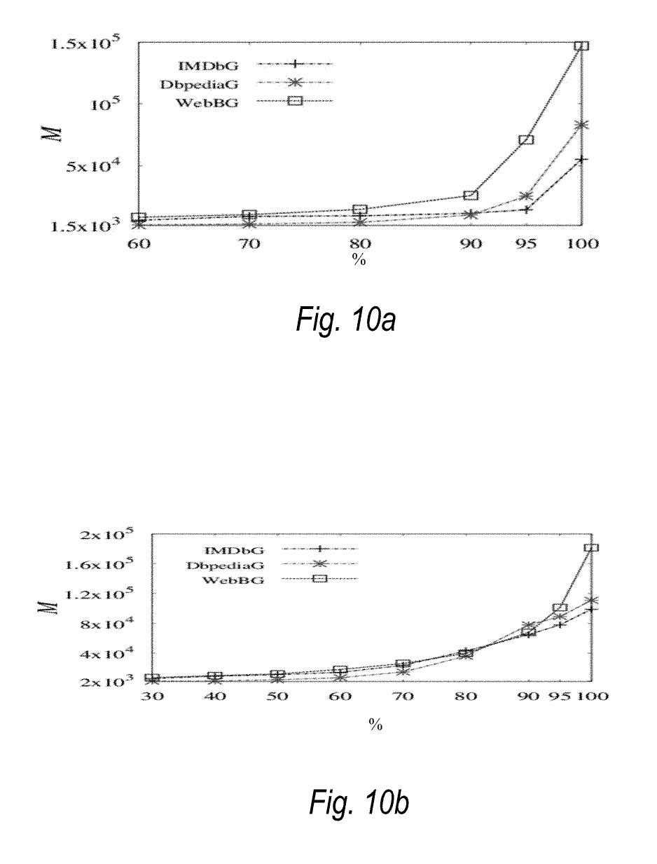

Varying x, the minimum M that makes x % of queries instance-bounded under M-bounded extensions on IMDbG, DBpediaG and WebBG graph databases, via EEChk and sEEChk methods, are examined. As FIGS. 10a and 10b show, a small M (compared to |G|) suffices to make a large percentage of the queries instance-bounded. For instance, when M is 14,113, 25,218 and 70,916 (resp. 77,873, 89,068, 101,134), over 95% of all subgraph (resp. simulation) queries which are randomly generated are instance-bounded in IMDbG, DBpediaG and WebBG graph databases, respectively. That is, M is approximately 0.057%, 0.107% and 0.006% of |G| (resp. 0.32%, 0.38% and 0.009%). When M is 181,448 (approximately 0.016% of WebBG graph database), all subgraph and simulation pattern queries become instance-bounded in all graph databases.

### Third Experiment: Efficiency

Efficiency of methods described herein are evaluated. EBChk, QPlan, sEBChk and sQPlan methods took at most 7 milliseconds (ms), 37 ms, 6 ms and 32 ms, respectively, for all pattern queries on the three graph databases with all the access constraints.

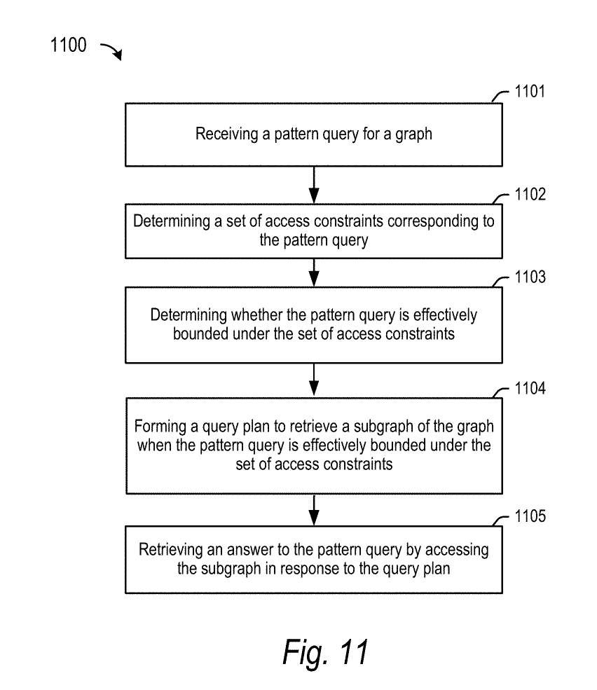

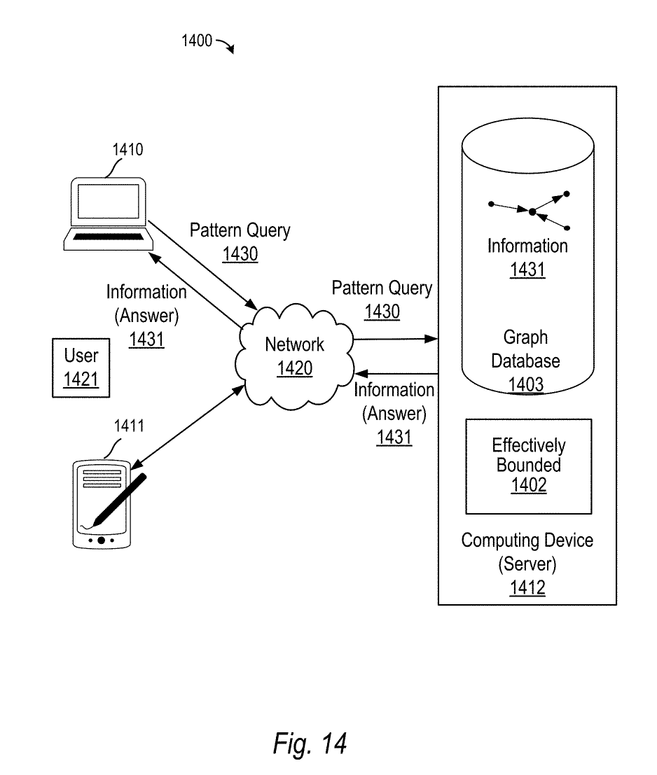

FIGS. 11-13 are flowcharts that illustrate methods for querying a big graph to obtain an answer to a pattern query according to embodiments of the present technology. In embodiments, flowcharts in FIGS. 11-14 are computer-implemented methods performed, at least partly, by hardware and software components illustrated in FIGS. 14-16 and as described below.

FIG. 11 illustrates a method 1100 where logic block 1101 shows receiving a pattern query for a graph. In an embodiment, I/O 1601 in FIG. 16 performs at least a portion of this function.

Logic block 1102 illustrates determining a set of access constraints corresponding to the pattern query. In an embodiment, determine access constraints 1602 in FIG. 16 performs at least a portion of this function.

Logic block 1103 illustrates determining whether the pattern query is effectively bounded under the set of access constraints. In an embodiment, determine effectively bounded 1603 in FIG. 16 performs at least a portion of this function.

Logic block 1104 illustrates forming a query plan to retrieve a subgraph of the graph when the pattern query is effectively bounded under the set of access constraints. In an embodiment, query plan 1604 in FIG. 16 performs at least a portion of this function.

Logic block 1105 illustrates retrieving an answer to the pattern query by accessing the subgraph in response to the query plan. In an embodiment, retrieve answer 1607 in FIG. 16 performs at least a portion of this function.

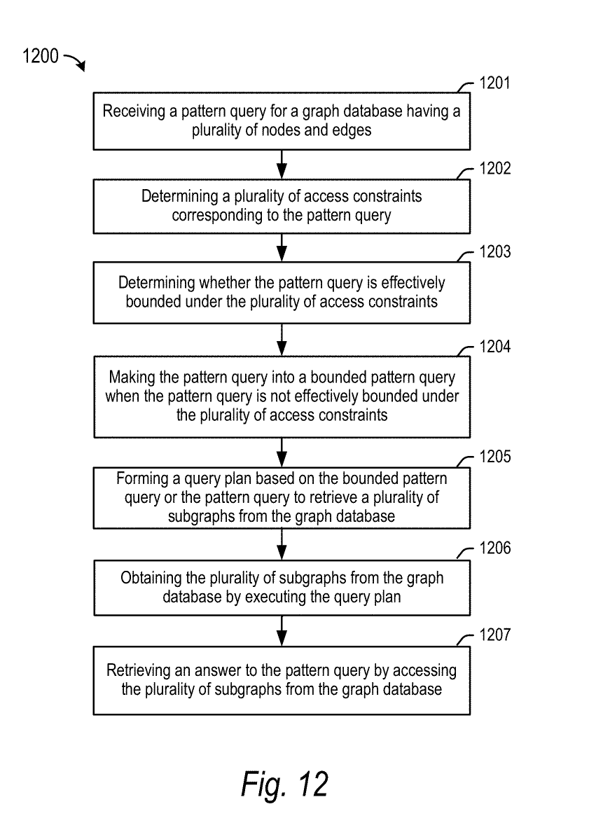

FIG. 12 illustrates a method 1200 where logic block 1201 illustrates receiving a pattern query for a graph database having a plurality of nodes and edges. In an embodiment, I/O 1601 in FIG. 16 performs at least a portion of this function.

Logic block 1202 illustrates determining a plurality of access constraints corresponding to the pattern query. In an embodiment, determine access constraints 1602 in FIG. 16 performs at least a portion of this function.

Logic block 1203 illustrates determining whether the pattern query is effectively bounded under the plurality of access constraints. In an embodiment, determine effectively bounded 1603 in FIG. 16 performs at least a portion of this function.

Logic block 1204 illustrates making the pattern query into a bounded pattern query when the pattern query is not effectively bounded under the plurality of access constraints. In an embodiment, make pattern query bounded 1605 in FIG. 16 performs at least a portion of this function.

Logic block 1205 illustrates forming a query plan based on the bounded pattern query or pattern query to retrieve a plurality of subgraphs from the graph database. In an embodiment, query plan 1604 in FIG. 16 performs at least a portion of this function.

Logic block 1206 illustrates obtaining the plurality of subgraphs from the graph database by executing the query plan. In an embodiment, obtain subgraphs 1606 in FIG. 16 performs at least a portion of this function.

Logic block 1207 illustrates retrieving an answer to the pattern query by accessing the plurality of subgraphs from the graph database. In an embodiment, retrieve answer 1607 in FIG. 16 performs at least a portion of this function.

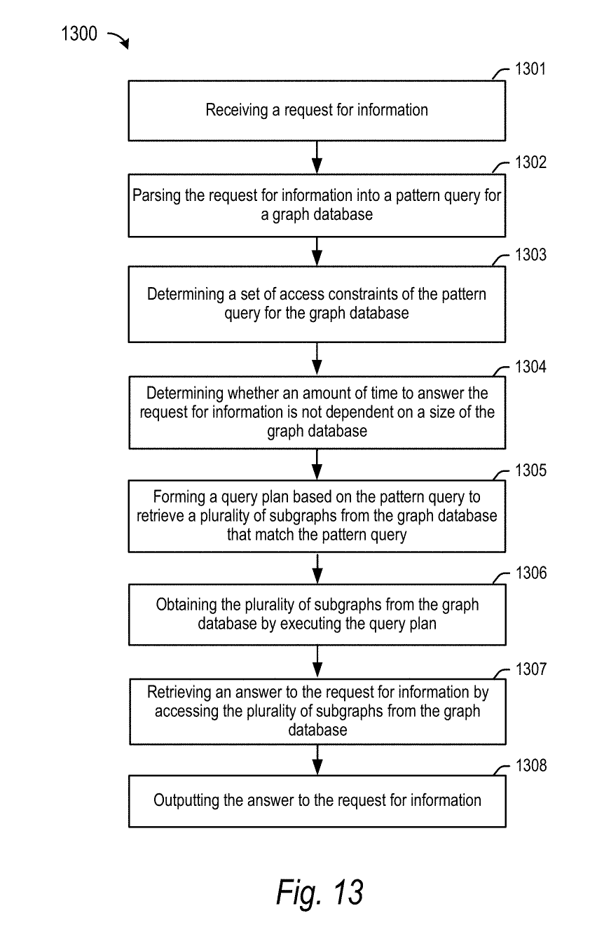

FIG. 13 illustrates a method 1300 where logic block 1301 illustrates receiving a request for information. In an embodiment, I/O 1601 in FIG. 16 performs at least a portion of this function.

Logic block 1302 illustrates parsing the request for information into a pattern query for a graph database. In an embodiment, parse 1601a in FIG. 16 performs at least a portion of this function. In an embodiment, a request for information may be a question or a natural language query.

Logic block 1303 illustrates determining a set of cardinality constraints of the pattern query for the graph database. In an embodiment, determine access constraints 1602 in FIG. 16 performs at least a portion of this function.

Logic block 1304 illustrates determining whether an amount of time to answer the request for information is not dependent on a size of the graph database. In an embodiment, determine effectively bounded 1603 in FIG. 16 performs at least a portion of this function.

Logic block 1305 illustrates forming a query plan based on the pattern query to retrieve a plurality of subgraphs from the graph database that match the pattern query. In an embodiment, query plan 1604 in FIG. 16 performs at least a portion of this function.

Logic block 1306 illustrates obtaining the plurality of subgraphs from the graph database by executing the query plan. In an embodiment, obtain subgraphs 1606 in FIG. 16 performs at least a portion of this function.

Logic block 1307 illustrates retrieving an answer to the request for information by accessing the plurality of subgraphs from the graph database. In an embodiment, retrieve answer 1607 in FIG. 16 performs at least a portion of this function.

Logic block 1308 illustrates outputting the answer to the request for information. In an embodiment, I/O 1601 in FIG. 16 performs at least a portion of this function.

FIG. 14 is a high-level block diagram of a system (or apparatus) 1400 for retrieving information (or answer) 1431, in response to pattern query 1430, from a graph database (or graph) 1403 that may include a big graph. System 1400 includes both hardware and software components in an embodiment. In an embodiment, system 1400 includes a plurality of computing devices (such as computers) 1410-1412 that are coupled to a network 1420. In embodiments, computing device 1410 is a laptop computing device and computing device 1411 is a cellular telephone (or smartphone). In an embodiment, computing device 1412 is embodied as a server. In other embodiments, more or fewer types of computing devices may be used. Types of computing device may include, but not limited to, wearable, personal digital assistant, cellular telephones, tablet, netbook, laptop, desktop, embedded and/or mainframe.

A user 1421 may use a computing device, such as computing devices 1410 and 1411, to submit a pattern query 1430 to computing device 1412 via network 1420 in order to retrieve information 1431 from graph database 1403. In an embodiment, graph database 1403 is a software component that stores a big graph that may be in the form of a database or dataset. In an embodiment, information 1431 is information obtained from one or more subgraphs of a big graph. In an embodiment, effectively bounded 1402 is a software component having computer instructions executed by computing device 1412 to retrieve information 1431 in response to pattern query 1430. In embodiments, effectively bounded 1402, among other functions as described herein, determines whether pattern query 1430 is effectively bounded under a set of access constraints and forms a query plan to obtain information 1431. Effectively bounded 1402 may also make pattern query 1430 bounded. Information 1431 is provided to computing device 1410 via network 1420 in response to computing device 1412 receiving a pattern query 1430 that may be localized or non-localized.

In embodiments, functions described herein are distributed to other or more computing devices. In an embodiment, graph database 1403 may be included in a separate computing device than computing device 1412 and may be accessible by computing device 1412 via network 1420. In an embodiment, graph database 1403 may be included in multiple computing devices. In embodiments, one or more computing device illustrated in FIG. 14 may act as a server that provides a service while one or more computing devices may act as a client. In an embodiment, one or more computing devices may act as peers in a peer-to-peer (P2P) relationship.

In embodiments, computing devices 1410-1412 may include one or more processors to read and/or execute computer instructions stored on a non-transitory computer-readable storage medium to provide at least some of the functions describe herein. For example, computing devices 1410-1412 may have user interfaces as described herein to communicate with the respective computing devices. Further, computing devices 1410-1411 may submit pattern queries to computing device 1412 while computing device 1412 responds to the submitted pattern queries with information from graph database 1403. In an embodiment, computing device 1412 receives a pattern query in the form of a natural language questions and parses the natural language questions into a pattern query.

Computing devices 1410-1412 communicate or transfer information by way of network 1420. In an embodiment, network 1420 may be wired or wireless, singly or in combination. In an embodiment, network 1420 may be the Internet, a wide area network (WAN) or a local area network (LAN), singly or in combination. In an embodiment, network 1420 may include a High Speed Packet Access (HSPA) network, or other suitable wireless systems, such as for example Wireless Local Area Network (WLAN) or Wi-Fi (Institute of Electrical and Electronics Engineers' (IEEE) 802.11x). In an embodiment, computing devices 1410-1412 use one or more protocols to transfer information or packets, such as Transmission Control Protocol/Internet Protocol (TCP/IP). In embodiments, computing devices 1410-1412 include input/output (I/O) computer-readable instructions as well as hardware components, such as I/O circuits to receive and output information from and to other computing devices, via network 1420. In an embodiment, an I/O circuit may include at least a transmitter and receiver circuit.

FIG. 15 illustrates a hardware architecture 1500 for executing effectively bounded 1402. In particular, hardware architecture 1500 illustrates a computing device 1412 that may be a server to provide information 1431 in response to a pattern query 1430 in an embodiment. Computing device 1412 may be implemented in various embodiments. Computing devices may utilize all of the hardware and software components shown, or a subset of the components in embodiments. Levels of integration may vary depending on an embodiment. For example, memories 1520 and 1530 may be combined into a single memory or divided into many more memories. Furthermore, a computing device 1412 may contain multiple instances of a component, such as multiple processors (cores), memories, databases, transmitters, receivers, etc. Computing device 1412 may comprise a processor equipped with one or more input/output devices, such as network interfaces, storage interfaces, and the like. Computing device 1412 may include a processor 1510, a memory 1520 to store effectively bounded 1402, a memory 1530 to store graph database 1403, a user interface 1560 and network interface 1550 coupled by a interconnect 1570. Interconnect 1570 may include a bus for transferring signals having one or more type of architectures, such as a memory bus, memory controller, a peripheral bus or the like.

In an embodiment, processor 1510 may include one or more types of electronic processors having one or more cores. In an embodiment, processor 1510 is an integrated circuit processor that executes (or reads) computer instructions that may be included in code and/or software programs. In an embodiment, processor 1510 is a digital signal processor, baseband circuit, field programmable gate array, digital logic circuit and/or equivalent.

In embodiments, memories 1520 and 1530 may include non-transitory memory storage to store instructions.

For example, memory 1520 may comprise any type of system memory such as static random access memory (SRAM), dynamic random access memory (DRAM), synchronous DRAM (SDRAM), read-only memory (ROM), a combination thereof, or the like. In an embodiment, a memory 1520 may include ROM for use at boot-up, and DRAM for program and data storage for use while executing instructions, such as effectively bounded 1402. In embodiments, memory 1520 is non-transitory or non-volatile integrated circuit memory storage.

Memory 1530 may comprise any type of memory storage device configured to store data, software programs including instructions, and other information and to make the data, software programs, and other information accessible via interconnect 1570. Memory 1530 may comprise, for example, one or more of a solid state drive, hard disk drive, magnetic disk drive, optical disk drive, or the like. In an embodiment, memory 1530 stores graph database 1403 that may include a big graph. In embodiments, memory 1530 is non-transitory or non-volatile integrated circuit memory storage.

Computing device 1412 also includes one or more network interfaces 1550, which may comprise wired links, such as an Ethernet cable or the like, and/or wireless links to access network 1420. A network interface 1550 allows computing device 1412 to communicate with remote computing devices via the networks 1420. For example, a network interface 1550 may provide wireless communication via one or more transmitters/transmit antennas and one or more receivers/receive antennas.

User interface 1560 may include computer instructions as well as hardware components in embodiments. A user interface 1560 may include input devices such as a touchscreen, microphone, camera, keyboard, mouse, pointing device and/or position sensors. Similarly, a user interface 1560 may include output devices, such as a display, vibrator and/or speaker, to output images, characters, vibrations, speech and/or video as an output. A user interface 1560 may also include a natural user interface where a user may speak, touch or gesture to provide input.

FIG. 16 illustrates a software architecture 1600 of effectively bounded 1402. Software architecture 1600 illustrates software components having computer instructions to at least provide information or an answer from a graph in response to a pattern query. In embodiments, software components illustrated in FIG. 16 may be embodied as a software program, software object, software function, software subroutine, software method, software instance, script and/or a code fragment, singly or in combination. In order to clearly describe the technology, software components shown in FIG. 16 are described as individual components. In embodiments, the software components illustrated in FIG. 16, singly or in combination, may be stored (in single or distributed computer-readable storage medium(s)) and/or executed by a single or distributed computing device (processor) architecture. Functions performed by the various software components described herein are exemplary. In other embodiments, software components identified herein may perform more or less functions. In embodiments, software components may be combined or further separated.

In an embodiments, effectively bounded 1402 is a software component that includes or communicates with the following software components: Input/output (I/O) 1601 including parse 1601a, determine access constraints 1602, determine effectively bounded 1603, query plan 1604, make pattern query bounded 1605, obtain subgraphs 1606 and retrieve answer 1607.

I/O 1601 is responsible for, among other functions, receiving a query, such as pattern query 1430 and outputting information from a graph database, such as information 1431 shown in FIG. 14 in an embodiment. In an embodiment, I/O 1601 includes parse 1601 that may parse a received natural language question or query into a pattern query. In embodiments, I/O 1601 may output other information, such as indicating that a “Query is not effectively bounded,” or a query plan that may be used to obtain information 1431.

Determine access constraints 1602 is responsible for, among other functions, determining access constraints of a pattern query 1430 in an embodiment. In an embodiment, determine access contraints 1602 determines a type of access constraints in a pattern query 1430 that is received by I/O 1601. In an embodiment, determine access constraints 1602 determines cardinality contraints and indices of a pattern query 1430 or a simulation pattern query.

Determine effectively bounded 1603 is responsible for, among other functions, determining whether a pattern query is effectively bounded in an embodiment. In an embodiment, determine effectively bounded 1603 receives a pattern query to be evaluated or analyzed from I/O 1601. In an embodiment, determine effectively bounded 1603 determines whether a pattern query is effectively bounded. In an embodiment, determine effectively bounded 1603 determines whether the received pattern query or simulation pattern query is covered by a particular access schema A or extended access schema A_{M}.

Query plan 1604 is responsible for, among other functions, forming a query plan for a received pattern query in an embodiment. In an embodiment, query plan 1604 forms a query plan when determine effectively bounded 1603 indicates that a received pattern query is effectively bounded. In an embodiment, query plan 1604 provides a query plan to obtain subgraphs 1606. In an embodiment, query plan 1604 provides a query plan to obtain subgraphs 1606 for retrieving matching subgraphs from graph database 1403 In an embodiment, query plan 1604 includes a sequence of fetching operations for a pattern query or simulation pattern query.

Make pattern query bounded 1605 is responsible for, among other functions, making a pattern query that is not effectively bounded into pattern query that is instance-bounded. In an embodiment, make pattern query bounded 1605 makes a pattern query instance-bounded by adding one or more additional constraints. In an embodiment, make query bounded 1605 uses a large natural number to extend types of access constraints in order to make a pattern query or simulation pattern query instance-bounded. In an embodiment, make pattern query bounded 1605 provides one or more pattern queries that are instance-bounded to query plan 1604 so that a query plan may be formed.

Obtain subgraphs 1606 is responsible for, among other functions, obtaining one or more subgraphs that match a received pattern query by executing a query plan from query plan 1604 in an embodiment. In an embodiment, obtain subgraphs 1606 identifies or obtains a plurality of subgraphs. In an embodiment, obtain subgraphs 1606 stores the plurality of matched subgraphs in non-transitory memory, such as memory 1520.

Retrieve answer 1607 retrieves requested information or an answer to a pattern query by accessing a plurality of subgraphs identified or stored by obtain subgraphs 1606. In an embodiment, retrieve answer 1607 forwards an answer or requested information to I/O 1601 that outputs the requested information.

The flowcharts and block diagrams in the figures illustrate the architecture, functionality, and operation of possible implementations of a device, apparatus, system, computer-readable medium and method according to various aspects of the present disclosure. In this regard, each block (or arrow) in the flowcharts or block diagrams may represent operations of a system component, software component or hardware component for implementing the specified logical function(s). It should also be noted that, in some alternative implementations, the functions noted in the block may occur out of the order noted in the figures. For example, two blocks (or arrows) shown in succession may, in fact, be executed substantially concurrently, or the blocks (or arrows) may sometimes be executed in the reverse order, depending upon the functionality involved. It will also be noted that each block (or arrow) of the block diagrams and/or flowchart illustration, and combinations of blocks (or arrows) in the block diagram and/or flowchart illustration, can be implemented by special purpose hardware-based systems that perform the specified functions or acts, or combinations of special purpose hardware and computer instructions.

It will be understood that each block (or arrow) of the flowchart illustrations and/or block diagrams, and combinations of blocks (or arrows) in the flowchart illustrations and/or block diagrams, may be implemented by non-transitory computer instructions. These computer instructions may be provided to and executed (or read) by a processor of a general purpose computer (or computing device), special purpose computer, or other programmable data processing apparatus to produce a machine, such that the instructions executed via the processor, create a mechanism for implementing the functions/acts specified in the flowcharts and/or block diagrams.

As described herein, aspects of the present disclosure may take the form of at least a device having one or more processors executing instructions stored in non-transitory memory storage, a computer-implemented method, and/or non-transitory computer-readable storage medium storing computer instructions.

Non-transitory computer-readable media includes all types of computer readable media, including magnetic storage media, optical storage media, and solid state storage media and specifically excludes signals. It should be understood that software including computer instructions can be installed in and sold with a computing device having computer-readable storage media. Alternatively, software can be obtained and loaded into a computing device, including obtaining the software via a disc medium or from any manner of network or distribution system, including, for example, from a server owned by a software creator or from a server not owned but used by the software creator. The software can be stored on a server for distribution over the Internet, for example.

More specific examples of the computer-readable storage medium include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing.

Non-transitory computer instructions for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The computer instructions may execute entirely on the user's computer (or computing device), partly on the user's computer, as a stand-alone software package, partly on the user's computer and partly on a remote computer, or entirely on the remote computer or server. In the latter scenario, the remote computer may be connected to the user's computer through any type of network, or the connection may be made to an external computer (for example, through the Internet using an Internet Service Provider) or in a cloud computing environment or offered as a service such as a Software as a Service (SaaS).

The description of the present disclosure has been presented for purposes of illustration and description, but is not intended to be exhaustive or limited to the disclosure in the form disclosed. Many modifications and variations will be apparent without departing from the scope and spirit of the disclosure. The aspects of the disclosure herein were chosen and described in order to best explain the principles of the disclosure and the practical application, and to enable others to understand the disclosure with various modifications as are suited to the particular use contemplated.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A device, comprising:
a non-transitory memory storing instructions; and
one or more processors in communication with the non-transitory memory storage, wherein the one or more processors execute the instructions to:
receive a pattern query for a graph,
determine a set of access constraints corresponding to the pattern query,
determine whether the pattern query is effectively bounded under the set of access constraints,
form a query plan to retrieve a subgraph of the graph when the pattern query is effectively bounded under the set of access constraints, and
retrieve an answer to the pattern query by accessing the subgraph in response to the query plan.

2. The device of claim 1, wherein an amount of time to retrieve the answer is dependent on the pattern query and the set of access constraints and is not dependent on a size of the graph.

3. The device of claim 1, wherein the set of access constraints includes an access constraint that is a cardinality constraint on a node having a first label in the pattern query and an index on a neighbor node having a second label.

4. The device of claim 3, comprising the one or more processors execute the instructions to make the pattern query effectively bounded under the set of access constraints when the pattern query is not effectively bounded under the set of access constraints.

5. The device of claim 4, wherein the one or more processors execute the instructions to add another access constraint to the set of access constraints and therefore make the pattern query effectively bounded under the set of access constraints when the pattern query is not effectively bounded.

6. The device of claim 1, wherein the one or more processors execute the instructions to determine whether the pattern query is effectively bounded under the set of access constraints includes the one or more processors execute the instructions to determine at least one actualized constraint of the set of access constraints (A) on the pattern query (Q) and compute VCov (Q,A).

7. The device of claim 1, wherein the graph includes a plurality of nodes and edges, wherein the one or more processors execute the instructions to form the query plan to retrieve the subgraph of the graph when the pattern query is effectively bounded under the set of access constraints includes the one or more processors execute the instructions to complete a sequence of fetch operations, wherein a fetch operation in the sequence of fetch operations includes retrieving information from a set of nodes or edges in the graph that correspond to a node or edge in the pattern query.

8. The device of claim 1, wherein the subgraph is isomorphic to the pattern query.

9. The device of claim 1, wherein the pattern query is a simulation pattern query.

10. A computer-implemented method comprising:
receiving, with one or more processors, a pattern query for a graph database having a plurality of nodes and edges;
determining, with one or more processors, a plurality of access constraints corresponding to the pattern query;
determining, with one or more processors, whether the pattern query is effectively bounded under the plurality of access constraints;
making, with one or more processors, the pattern query into a bounded pattern query when the pattern query is not effectively bounded under the plurality of access constraints;
forming, with one or more processors, a query plan based on the bounded pattern query or the pattern query to retrieve a plurality of subgraphs from the graph database;
obtaining, with one or more processors, the plurality of subgraphs from the graph database by executing the query plan; and
retrieving, with one or more processors, an answer to the pattern query by accessing the plurality of subgraphs from the graph database.

11. The computer-implemented method of claim 10, comprising determining, with one or more processors, whether the pattern query is localized or non-localized.

12. The computer-implemented method of claim 10, wherein the pattern query includes a set of labeled nodes and edges, and wherein the plurality of access constraints have at least two types of access constraints including a first cardinality constraint on a first labeled node in the set of labeled nodes and edges and a second cardinality constraint that includes an index on neighboring nodes of each labeled node in the set of labeled nodes and edges.

13. The computer-implemented method of claim 12, wherein forming, with one or more processors, the query plan based on the bounded pattern query or the pattern query to retrieve the plurality of subgraphs from the graph database comprises:
inspecting each labeled node in the set of labeled nodes and edges,
determining an access constraint in the plurality of access constraints so that an index is used to retrieve a set of candidate nodes for each labeled node,
generating a node fetching operation using the index, and
storing the node fetching operation in the query plan.

14. The computer-implemented method of claim 10, wherein making, with one or more processors, the pattern query into the bounded pattern query when the pattern query is not effectively bounded under the plurality of access constraints comprises determining a natural number that may be used with a first access constraint in the plurality of access constraints.

15. The computer-implemented method of claim 10, wherein retrieving, with one or more processors, the answer to the pattern query by accessing the plurality of subgraphs from the graph database takes an amount of time that is dependent on the pattern query and the plurality of access constraints.

16. A non-transitory computer-readable medium storing computer instructions, that when executed by one or more processors, cause the one or more processors to:
receive a request for information;
parse the request into a pattern query for a graph database;
determine a set of access constraints of the pattern query for the graph database;
determine whether an amount of time to answer the request for information is not dependent on a size of the graph database;
form a query plan based on the pattern query to retrieve a plurality of subgraphs from the graph database that match the pattern query;
obtain the plurality of subgraphs from the graph database by executing the query plan;
retrieve an answer to the request for information by accessing the plurality of subgraphs from the graph database; and
output the answer to the request for information.

17. The non-transitory computer-readable medium of claim 16, wherein determining whether the amount of time to answer the request for information includes determining whether the pattern query is effectively bounded under the set of access constraints.

18. The non-transitory computer-readable medium of claim 17, wherein the pattern query includes a plurality of nodes and edges, wherein the set of access constraints includes an access constraint that is a cardinality constraint on a node having a first label in the pattern query and an index on a neighbor node having a second label.

19. The non-transitory computer-readable medium of claim 18, further comprising extend the set of access constraints by adding a natural number to one or more access constraints in the set of access constraints when the pattern query is not effectively bounded under the set of access constraints.

20. The non-transitory computer-readable medium of claim 18, wherein forming a query plan includes forming a plurality of fetch operations, wherein a fetch operation in the plurality of fetch operations includes a retrieve information operation from a set of nodes or edges in the graph database that correspond to a node or an edge in the plurality of nodes and edges of the pattern query.
